(19) United States
(12) Patent Application Publication
(10) Pub. No.: US 2003/0043071 A1
(43) Pub. Date: Mar. 6, 2003

(54) Electro-mechanical scanned array system and method

(75) Inventors: James D. Lilly, Silver Springs, MD (US); William E. McKinzie III, Fulton, MD (US)

Correspondence Address: BRINKS HOFER GILSON & LIONE, P.O. BOX 10395, CHICAGO, IL, 60611, US

(73) Assignee: e-tenna Corporation

(21) Appl. No.: 09/941,299

(22) Filed: Aug. 27, 2001

(51) Int. Cl. H01Q 3/22; H01Q 3/24

(52) U.S. Cl. 342/368

(57) ABSTRACT

An antenna system includes a beamformer having a feed port and a one-dimensional or two-dimensional arrangement of output ports, radiating antenna elements coupled with output ports of the beamformer, and an antenna control unit coupled with the beamformer to steer a beam of the antenna system. The antenna system forms an electrically steerable, phased array antenna having a beam steering angle which is constant over a very broad band of frequencies. Specific applications for the antenna system include satellite communications including tracking low earth orbiting satellites, radar systems and data links using a steerable antenna for self-installation, self-healing and adaptation.

### RELATED APPLICATIONS

This application is related to application Ser. No. 09/839,323 entitled “Variable Time-Delay Microwave Transmission Line,” filed Apr. 20, 2001 in the name of James D. Lilly, and application Ser. No. 09/863,975 entitled “Planar, Fractal, Time-Delay Beamformer,” filed May 23, 2001 in the names of William E. McKinzie, III and James D. Lilly, both of which are commonly assigned to the assignee of the present application and incorporated in their entirety herein by this reference.

### BACKGROUND

This application relates generally to phased arrays. More particularly, this application relates to electro-mechanical scanned array systems and methods.

Phased arrays are electronic devices used in forming antenna systems. A phased array antenna includes an array of antenna elements which produces one or more steerable beams of radio frequency energy. The relative amplitude and phase shift across the array of antenna elements defines the antenna beam. This relative amplitude and phase state has been produced in the past by controllable attenuators and phase shifters coupled to corresponding antenna elements or by beamforming networks disposed between a plurality of beam ports and the plurality of antenna elements, where each beam port corresponds to one of the beams.

There is a variety of applications requiring low cost phased array antenna systems. These include communications and radar systems. For example, self-installing User Equipment (UE) terminal antennas are needed for multi-channel, multi-point distribution services (MMDS) radio systems, local multi-point distribution service (LMDS) radio systems, and other communications systems. In another example, high-gain tracking antennas are needed for satellite communication systems that have low-earth orbit (LEO) satellites. In yet another example, cellular base-station antennas, which are typically linear arrays, need the ability to control electrical down-tilt, either once (at installation) or dynamically as system conditions change. These and-other systems must be relatively broad band for example, for operation in dual-band cellular radio systems.

Existing phased array technology is unacceptably expensive for most of these applications. Existing technology is also narrow-band, and thus cannot be employed in multi-frequency or relatively broadband systems such as dual-band cellular base station antennas.

Conventional phased array devices use beamformers to control the antenna beam. The conventional beamformer, in turn, uses phase shifters to adjust the phase of input signals in accordance with control signals provided from an external controller. Each control signal is provided to an individual phase shifter and may either tune the phase difference of the phase shifter or simply turn on the phase shifter, thereby applying a set amount of phase difference to the input signal. Such conventional phase shifters are thus relatively bulky and expensive. Phase shifters are also generally radio frequency (RF)-active devices that require a comparatively large amount of power and may interfere with the transmitted signal. Another disadvantage is that, because the phase shifter alters the phase of an input signal thereby only simulating a time delay, a fixed, progressive time delay between elements is obtained only over a relatively narrow band of frequencies.

Accordingly, there is a need for an improved antenna system and method for a phased array antenna system using improved technology to reduce the cost, power drain, size and weight of such a system including a beamformer and providing improved performance including broadband operation.

### BRIEF SUMMARY

By way of introduction only, in one embodiment, the present invention provides an antenna system including a beamformer having a feed port and a two dimensional arrangement of output ports, radiating antenna elements coupled with output ports of the beamformer; and an antenna control unit coupled with the beamformer to steer a beam of the antenna system.

In another embodiment, the present invention provides an antenna system including a fractal corporate power divider beamformer having a feed port and output ports, radiating antenna elements coupled with output ports of the beamformer, and an antenna control unit coupled with the beamformer to steer a beam of the antenna system.

In yet another embodiment, the present invention provides a radio including a transmit circuit, a receive circuit, a diplexer coupled with the transmit circuit and the receive circuit and two or more radiating antenna elements. The radio further includes a fractal corporate power divider beamformer having a feed port coupled with the diplexer and two or more output ports coupled with the two or more radiating antenna elements and an antenna control unit configured to provide control signals to the beamformer to steer an antenna beam.

In yet another embodiment, the present invention provides a method for directing a beam of an antenna. The method includes receiving information associated with a desired scan angle, calculating delays between delayers of a fractal corporate power divider beamformer, generating control signals based on the calculated delays, and communicating the control signals to the beamformer.

In yet another embodiment, the present invention provides a self-installing radio operable in a radio system. The self-installing radio includes radio equipment for radio communication with a remote radio of the radio system and an antenna system coupled with the radio equipment. The antenna system includes a planar, fractal beamformer having a plurality of controllable variable time delay elements responsive to control signals for delaying radio frequency (RF) signals between a feed port and a plurality of output ports, and an array of radiating elements coupled with the plurality of output ports. The radio further includes a control circuit coupled with the beamformer to provide the control signals in response to an estimation of a pointing angle to the remote radio.

In yet another embodiment, the present invention provides an antenna system for user equipment (UE) of a satellite radio communication system including a plurality of earth-orbiting satellites. The antenna system includes a planar, fractal beamformer having a plurality of controllable variable time delay elements responsive to control signals for delaying radio frequency (RF) signals between a feed port and a plurality of output ports, an array of radiating elements coupled with the plurality of output ports, and a control circuit coupled with the beamformer to provide the control signals in response to an estimation of a pointing angle to a satellite of the satellite radio communication system.

In yet another embodiment, the present invention provides an open loop steering method for a phased array antenna system. The method includes determining a desired scan angle for a beam of the phased array antenna system, based on the desired scan angle, determining delays for time delay devices of a beamformer of the phased array antenna system and based on the delays, producing a plurality of control signals and providing the control signals to the beamformer. The method further includes, at the beamformer, in response to the control signals, establishing time delays between a feed port and output ports of the beamformer, providing a radio frequency signal to the feed port of the beamformer, selectively delaying the RF signal according to the established time delays to provide delayed output signals from the output ports to radiating elements of the beamformer, sampling a transmitted signal at the radiating elements, determining error corrections, producing corrected control signals and conveying the corrected control signals to the beamformer.

In yet another embodiment, the present invention provides a closed loop steering method for a phased array antenna system. The method includes determining a desired scan angle for a beam of the phased array antenna system, based on the desired scan angle, determining delays for time delay devices of a beamformer of the phased array antenna system, and based on the delays, producing a plurality of control signals. The method further includes modulating the control signals to modulate the scan angle and providing the modulated control signals to the beamformer. The method still further includes at the beamformer, in response to the modulated control signals, establishing time delays between a feed port and output ports of the beamformer, sampling a received signal quality indication, determining error corrections based on the sampled received signal quality indication, producing corrected control signals based on the error corrections and providing the corrected control signals to the beamformer.

In yet another embodiment, the present invention provides a method for a radio including a phased array antenna system. The method includes applying control signals to variable time delay elements of a planar fractal beamformer to steer an antenna beam, detecting a signal quality indication associated with radio communication with a remote radio target, and steering the antenna beam to vary signal quality indication.

In yet another embodiment, the present invention provides a method for a radio including a phased array antenna system. The method includes steering an antenna beam to a remote radio target with a planar fractal beamformer, detecting a signal quality indication associated with radio communication with the remote radio target, and applying corrected control signals to time delay elements of the planar fractal beamformer to steer the antenna beam to improve the signal quality indication.

In yet another embodiment, the present invention provides a manufacturing method for a radio including a phased array antenna system, the method including determining a pointing angle for the phased array antenna system, providing beam steering control signals to a planar fractal beamformer of the phased array antenna system, and fixing the beam steering control signals to permanently select the pointing angle for the phased array antenna system.

The foregoing summary has been provided only by way of introduction. Nothing in this section should be taken as a limitation on the following claims, which define the scope of the invention.

### BRIEF DESCRIPTION OF SEVERAL VIEWS OF THE DRAWINGS

FIG. 1 is a cross-sectional view of a first embodiment of a microwave-frequency variable time-delay device;

FIG. 2 is a top view of the embodiment of FIG. 1

FIG. 3 is a partial cut-away top view of the embodiment of FIG. 1;

FIG. 4 is a sectional view of the embodiment of FIG. 1 in a non-actuated state;

FIG. 5 is a sectional view of the embodiment of FIG. 1 in an actuated state;

FIG. 6 is an enlarged sectional view of the embodiment of FIG. 1 in an actuated state;

FIG. 7 is a top view of a second embodiment of a microwave-frequency variable time-delay device;

FIG. 8 is a partial cut-away top view of the embodiment of FIG. 7;

FIG. 9 is a partial cut-away top view of a third embodiment of a microwave-frequency variable time-delay device;

FIG. 10 is a partial cut-away top view of a fourth embodiment of a microwave-frequency variable time-delay device;

FIG. 11 is a perspective view of a fifth embodiment of a microwave-frequency variable time-delay device;

FIG. 12 is a sectional view of the embodiment of FIG. 11 in a non-actuated state;

FIG. 13 is a sectional view of the embodiment of FIG. 11 in an actuated state in which the movable portion of the ground plane is pulled toward the stationary sheet;

FIG. 14 is a sectional view of the embodiment of FIG. 11 in an actuated state in which the movable portion of the ground plane is pushed toward the high-permittivity layer;

FIG. 15 is a plot of insertion phase vs. frequency of the first embodiment of FIG. 1;

FIG. 16 is a top view of a sixth embodiment of a microwave-frequency variable time-delay device;

FIG. 17 shows building blocks and various stages of a linear fractal tree;

FIG. 18 shows building blocks and various stages of a square fractal tree;

FIG. 19 illustrates a top view of a first embodiment of a beamformer scannable in two dimensions;

FIG. 20 shows a first embodiment of a digitally controlled delay element;

FIG. 21 shows a second embodiment of a digitally controlled delay element;

FIG. 22 relates the scanning direction vs. control signals applied to sets of delay elements in the embodiment of FIG. 20;

FIG. 23 illustrates a top view of a second embodiment of a beamformer scannable in two dimensions;

FIG. 24 illustrates a top view of an embodiment of a beamformer scannable in one dimension;

FIG. 25 is a first embodiment of an antenna system;

FIG. 26 is a second embodiment of an antenna system;

FIG. 27 is a flow diagram illustrating one embodiment of a method for operating a phased array system;

FIG. 28 is a flow diagram illustrating a second embodiment of a method for operating a phased array system;

FIG. 29 is a third embodiment of an antenna system;

FIG. 30 is a flow diagram illustrating a third embodiment of a method for operating a phased array system;

FIG. 31 is a fourth embodiment of an antenna system;

FIG. 32 is a block diagram of a radio system;

FIG. 33 is a flow diagram illustrating a method of operating a radio in the radio system of FIG. 32;

FIG. 34 is a flow diagram illustrating in detail a portion of the flow diagram of FIG. 33; and

FIG. 35 is a flow diagram illustrating in detail a portion of the flow diagram of FIG. 33.

### DETAILED DESCRIPTION OF THE PRESENTLY PREFERRED EMBODIMENTS

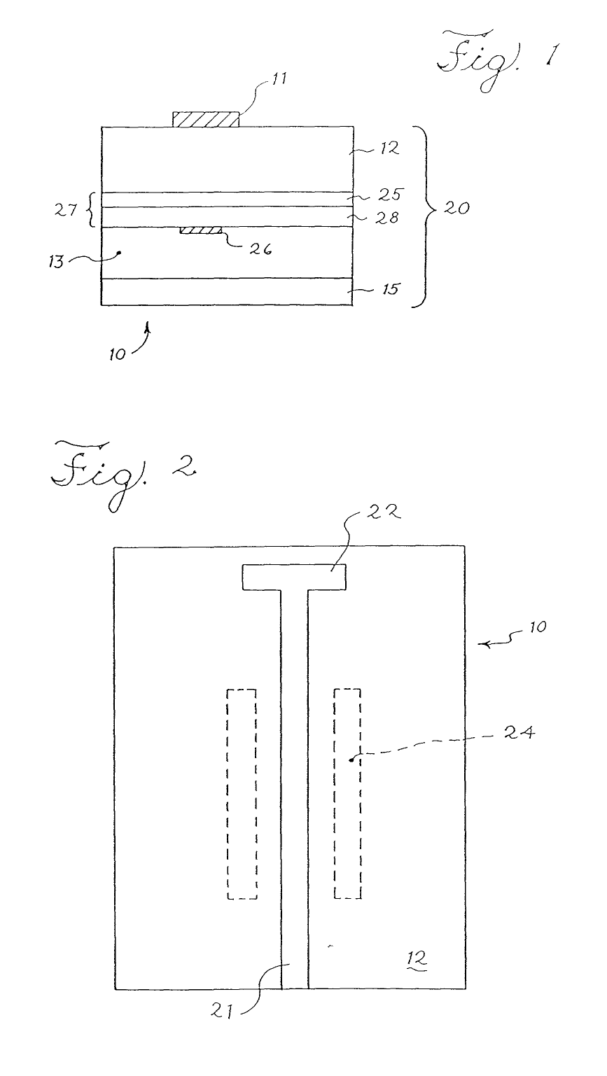

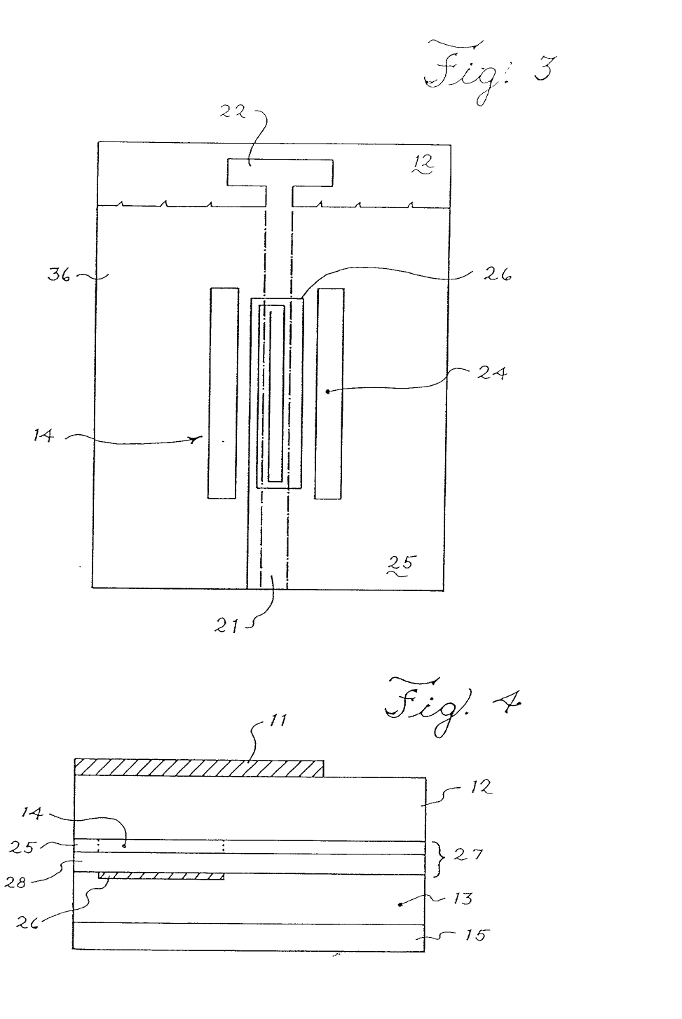

A first embodiment of a microwave-frequency variable time-delay device describes a mechanism for controlling the velocity of propagation and corresponding time delay of microwaves/microwave energy through a section of a transmission line. This time delay may be electronically controlled, using electromagnetic or mechanical actuation to translate electronic control signals to mechanical action as required to control the line. FIGS. 1 and 2 show a cross-sectional and top view, respectively, of an example of a high-frequency device that uses the first embodiment. The embodiments of FIGS. 1-16 may be of the type disclosed in application Ser. No. 09/839,323 entitled “Variable Time-Delay Microwave Transmission Line,” filed Apr. 20, 2001 in the name of James D. Lilly, which is commonly assigned with the present application and in incorporated herein by reference in its entirety.

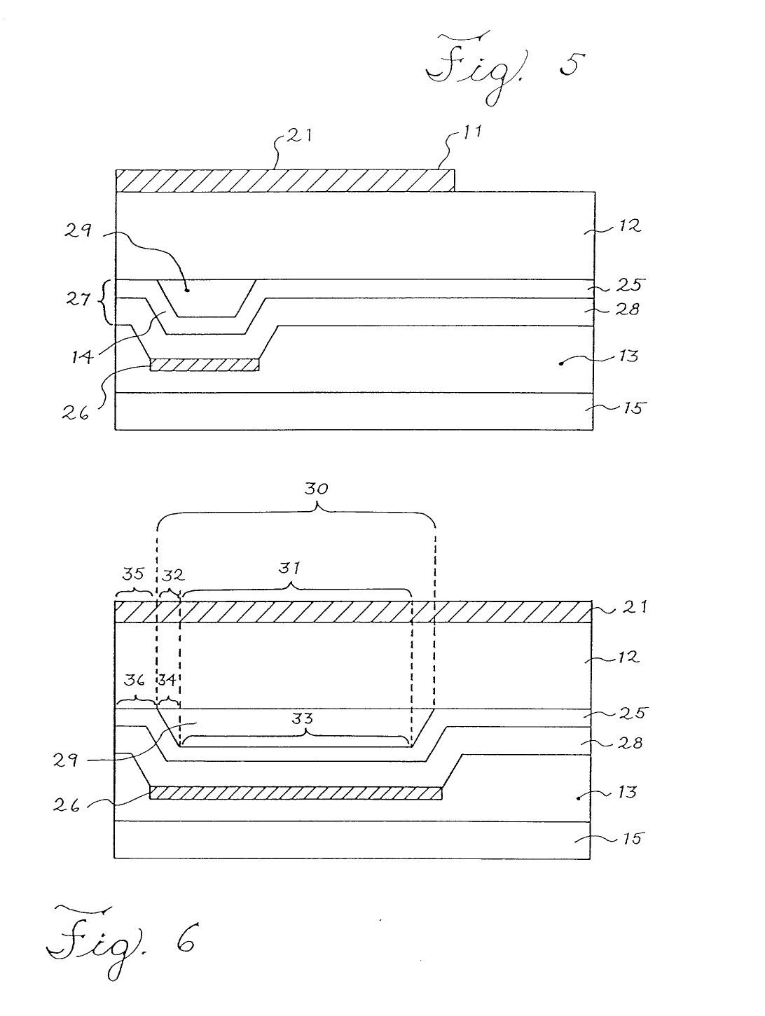

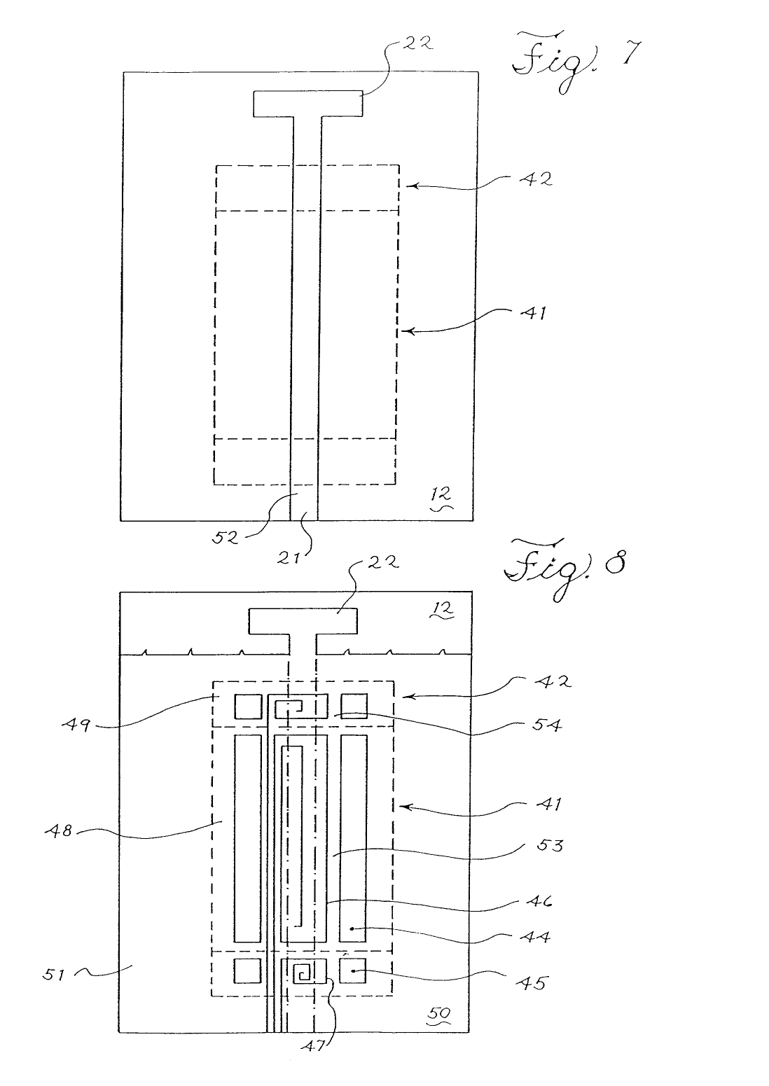

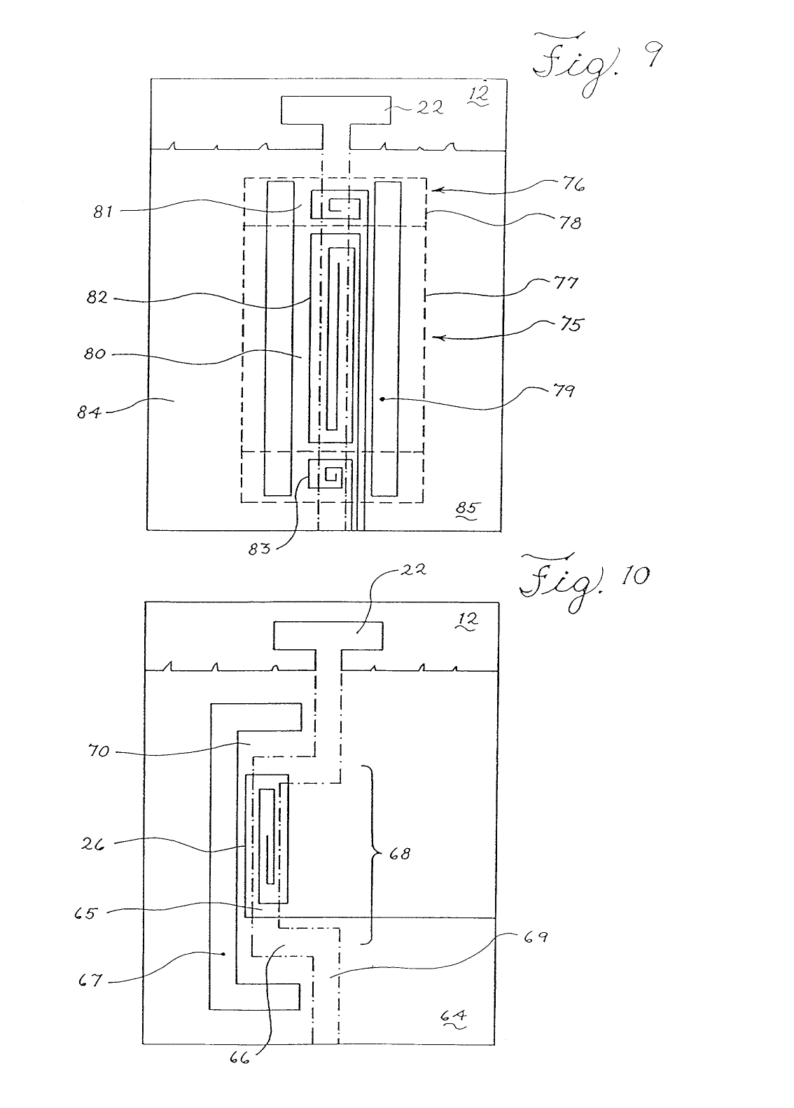

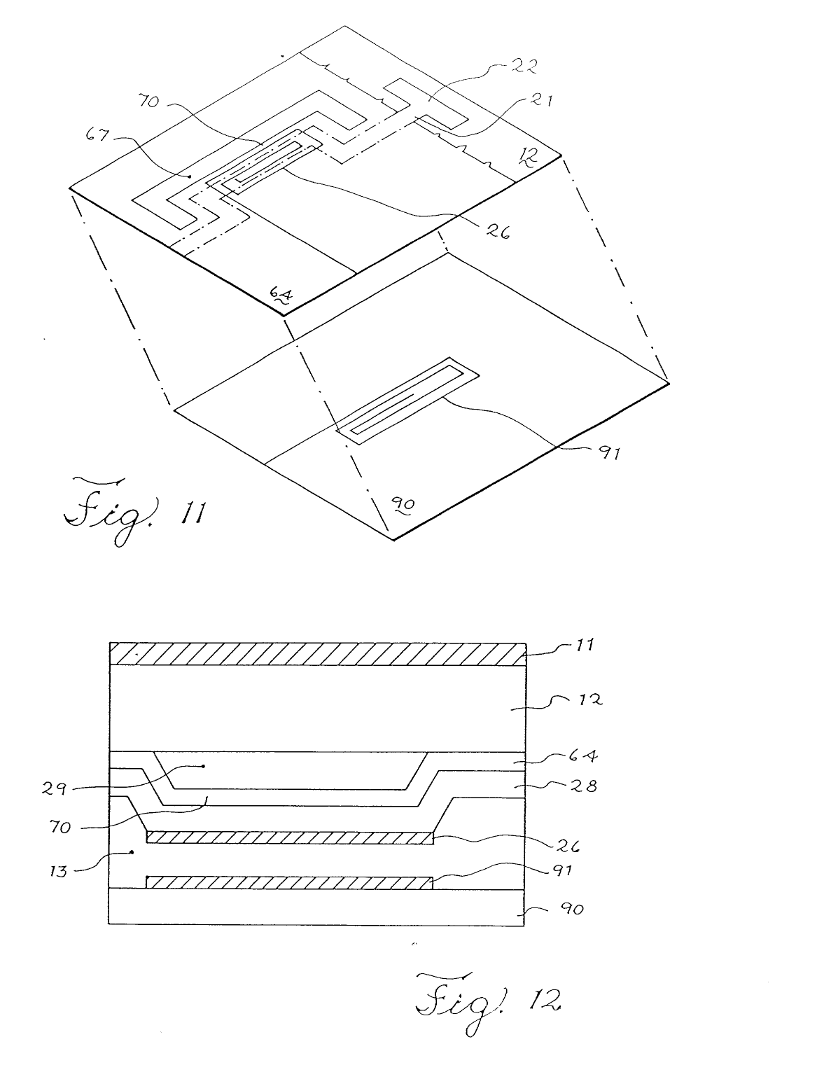

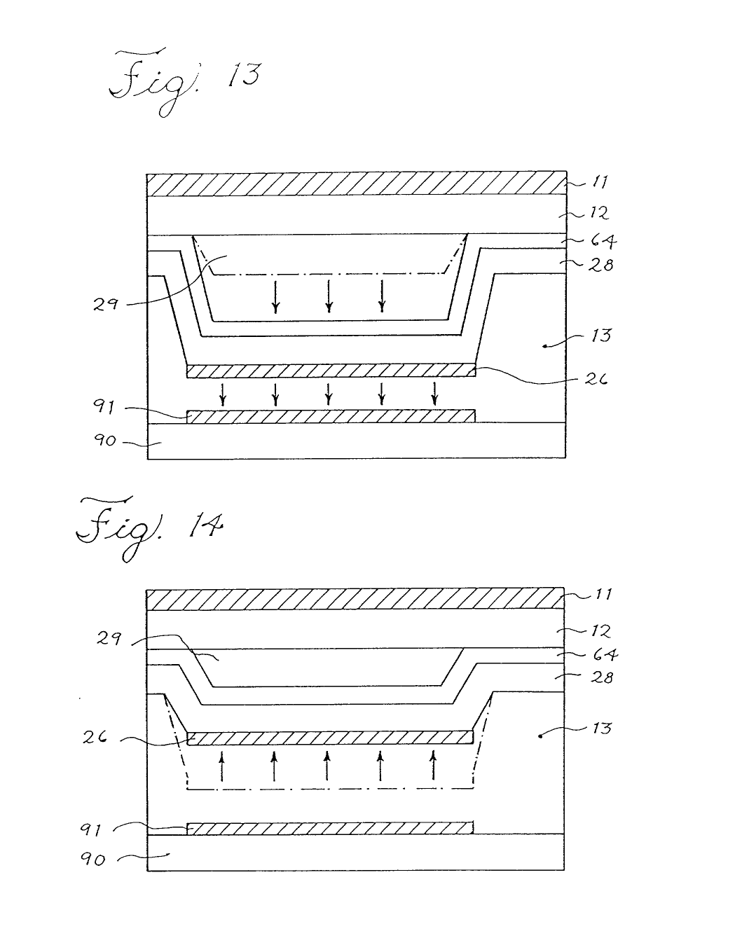

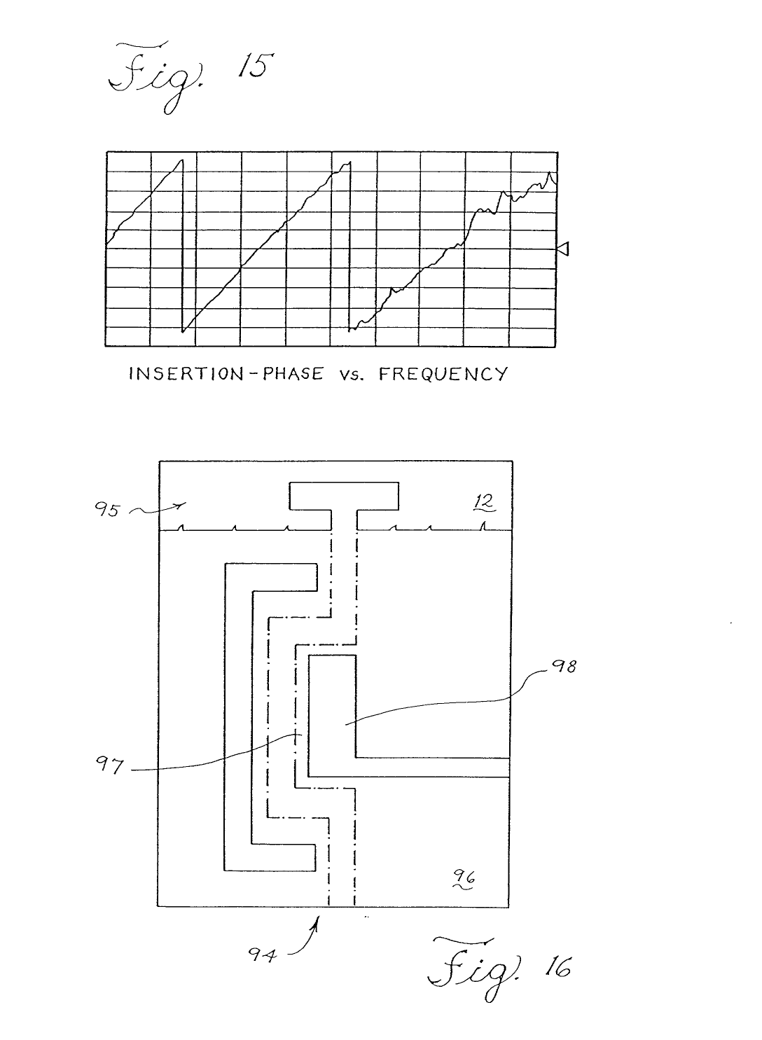

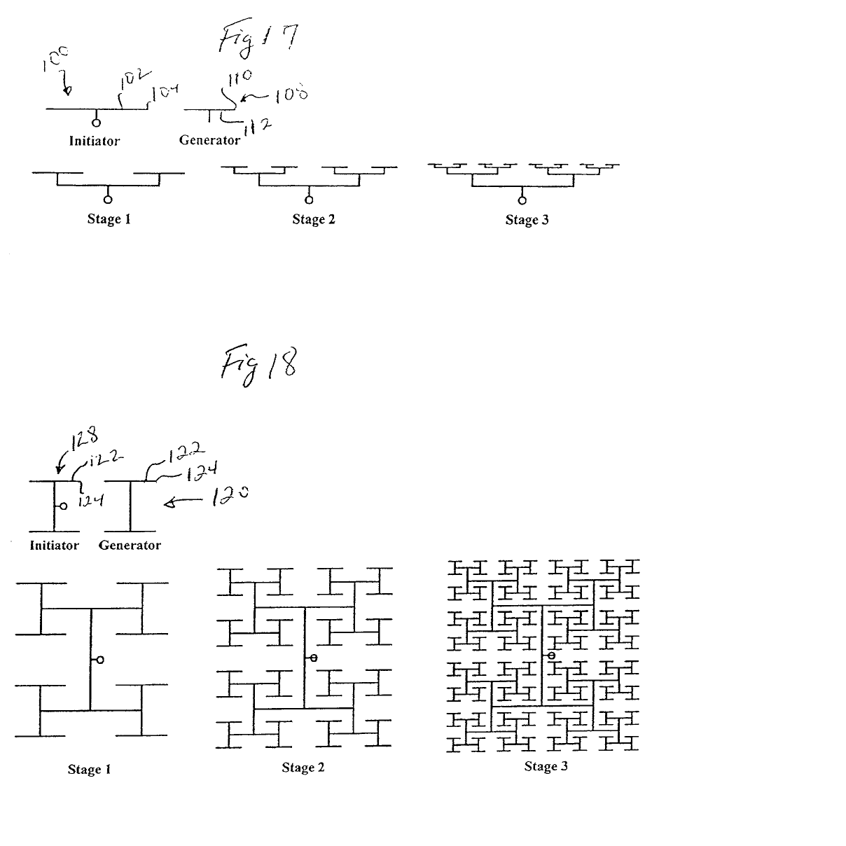

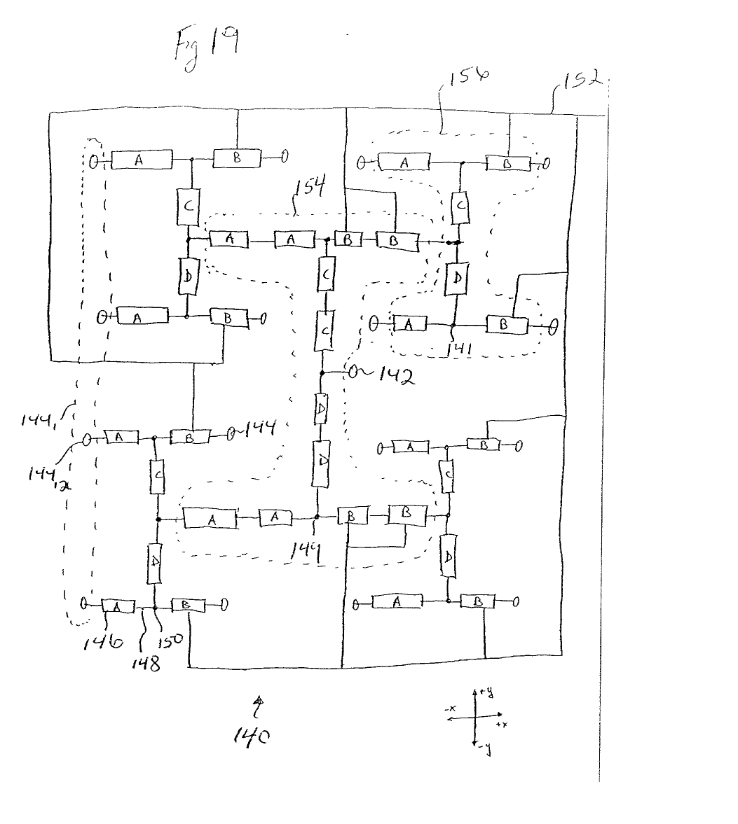

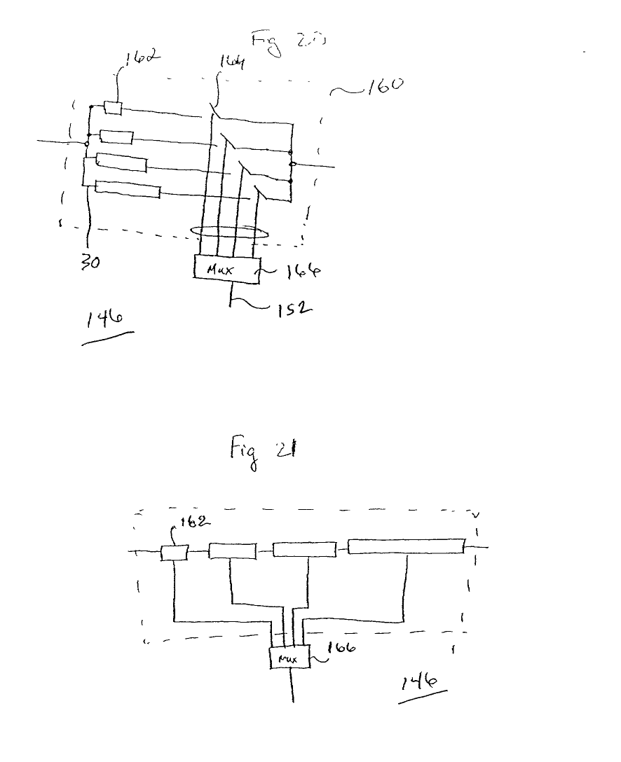

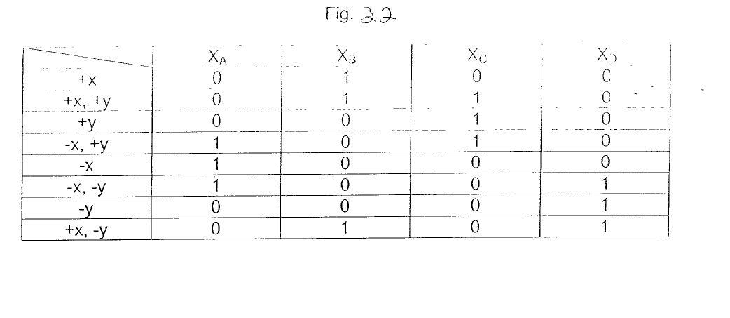

The device of FIGS. 1 and 2 may be operated as a phase shifter which has a variable and true time delay. The high-frequency device 10 may include a microwave transmission line 11 disposed on a composite, multi-layer substrate 20 having at least one printed circuit board. The composite substrate 20 may contain a fixed high permittivity layer 12, a flexible ground plane 25 having a movable portion 14, an air layer 13, and a stationary magnetic sheet 15, all in the vicinity of an active area of the composite substrate 20. FIG. 3 illustrates a top view of the high-frequency device cut-away to show the flexible ground plane 25.

The microwave transmission line 11 may contain a microstrip feedline 21 and a patch antenna 22. The microwave transmission line 11 thus forms a transmission line waveguide means for guiding an electromagnetic signal in three dimensions. The microwave transmission line 11 may be constructed from a conductor, such as copper, aluminum, silver, or a comparable alloy, to allow electromagnetic signals to propagate along the microstrip feedline 21 and optionally be transmitted by or received by the patch antenna 22. Although the device may be a broadband device, the wavelength of the signals transmitted along the microstrip feedline 21 may be optimized generally for a particular frequency range, such as either microwave signals or millimeter wave signals, e.g. say the Ka band (27-40 GHz range) or X band (10 GHz range). The microstrip feedline 21 and the patch antenna 22 in the first embodiment may be disposed on the same composite substrate 20, although it is not necessary for microstrip feedline 21 and the patch antenna 22 to be disposed on the same composite substrate. In certain applications where loss is paramount, for example, a satellite receive terminal array, materials with the lowest loss (such as alumina) may be used in the transmission line in addition to designing the length of the transmission line to be as short as possible. However, although loss is generally an important factor, fabricating a high-frequency variable time delay device having the lowest loss is not an absolute requirement as it depends on the specific use of the device.

Below the microstrip feedline 21, the composite substrate 20 may contain at least one fixed-thickness, high permittivity layer 12 and at least one variable thickness air layer 13 that has a permittivity less than the high permittivity layer 12. The composite substrate 20 may thus form a support means for physically supporting the transmission line waveguide means and may additionally have components that form a means for varying a permittivity that the guided electromagnetic signal encounters. The high-permittivity layer 12 may be positionally fixed with regard to the other non-moving layers, i.e. remains at a constant distance from the other immobile layers (such as the stationary sheet 15). The high permittivity layer 12 may be a non-conductive, solid dielectric material such as Al₂O₃ (ceramic alumina) or soft substrate organic material. The high permittivity layer 12 preferably may have εᵣ≧2, εᵣ≧5 or εᵣ≧10. The thickness of the high permittivity layer 12 may range preferably from about 1 μm to about 10 mm, about 5 μm to about 5 mm or about 1.0 μm to about 1 mm, dependent on the desired optimum frequency range. The microstrip feedline 21 is fabricated on the top surface of the high permittivity layer 12.

The composite substrate 20 may also contain a flexible layer 27 formed with a flexible ground plane 25 disposed below the high permittivity layer 12 and printed on or attached to a flexible substrate 28 such as Mylar™ or Kapton™ below the flexible ground plane 25. A planar solenoid coil 26 may be disposed on the bottom of the flexible layer 27 below the movable portion 14 of the ground plane 25. The flexible ground plane 25 may be a relatively thin metallic layer formed, for example, from copper. As shown in FIG. 4, the unactuated position (or quiescent position) to which the movable portion 10 of the ground plane 25 returns after actuation may be adjacent to the high permittivity layer 12. The air layer 13 may be disposed below the flexible layer 27, in the vicinity of the coil 26. The air layer 13 may range preferably from about 0.1 to about 1, about 0.25 to about 0.75, or about 0.4 to about 0.6 times the thickness of the high permittivity layer 12. The air layer 13, as above, has a lower dielectric constant (e.g. 1) than the high permittivity layer 12 (e.g. 10).

A stationary magnetic sheet 15 may be disposed below the air layer 13 and at least directly below and in the vicinity of the coil 26. The stationary magnetic sheet 15 may be composed of a ferrous material, such as iron or iron alloys, or permanent magnetic material. Alternatively, the stationary magnetic sheet 15 may be an active electromagnet containing one or more printed coils. If a permanent magnetic material is used, the permanent magnetic material may have either a single magnetic domain or multiple magnetic domains aligned in the same direction. The permanent magnetic material may contain either discrete permanent magnets or a sheet of some material, such as Si rubber or epoxy, filled with tiny magnetic particles (e.g. ferrite magnetic powder). In the latter case, one manner in which the magnetic particles may be magnetically aligned is by use of a strong magnetic field as the material is setting up, which would freeze the magnetic particles in the preferred direction.

Although air layer 13 exists in the vicinity of the active region proximate the coil 26, in regions of the composite substrate 20 that are distal to the coil 26, i.e. in which the flexible ground plane 25 does not move perpendicular to the stationary magnetic sheet 15, the entire thickness of this layer may be filled with an inexpensive filler material (not shown), such as fiberglass or foam. Thus, regions are essentially cut out or otherwise created in the filler material in the active region in which the movable portion 14 of the ground plane 25 moves toward the stationary sheet 15. The filler material serves as a spacer layer and provides mechanical support for the substrate 20, thereby rendering the thicknesses of the high permittivity layer 12 and stationary magnetic sheet 15 relatively unimportant for mechanical stability purposes. Alternatively, the stationary magnetic sheet 15 may be a stiff sheet of iron or steel, for instance, connected with the non-moving portion of the ground plane 25 via non-conducting posts, thereby also-providing any required mechanical support.

The coil 26 may be printed on the bottom of the flexible layer 27 using standard circuit printing (PCB) techniques and may be composed of a conductor such as copper, silver, aluminum, or a corresponding alloy of these materials, for example. As illustrated in FIG. 5, when a current is passed through the coil 26, the coil 26 may be electromechanically actuated. This is to say that the coil 26 may be pulled toward the stationary magnetic sheet 15 by the electromagnetic force between the coil 26 and the stationary magnetic sheet 15, thereby decreasing the distance between the coil 26 and therefore the movable portion 14 of the ground plane 25, and the stationary magnetic sheet 15. Similarly, the thickness of the air layer 13 between the coil 26 and stationary magnetic sheet 15 may be decreased and correspondingly, the thickness of an air gap 29 between the movable portion 14 of the ground plane 25 and the high permittivity layer 12 increased.

If a permanent magnetic material is used as the stationary magnetic sheet 15 rather than a ferrous material, the coil 26 may either be pushed away from or pulled towards the stationary magnetic sheet 15 by the electromagnetic force between the coil 26 and the stationary magnetic sheet 15 (depending on the direction of current). In this case, an additional air layer may be formed between the flexible layer 27 and the high permittivity layer 12 to allow the movable portion 14 of the ground plane 25 to decrease when actuated (i.e. the quiescent position of the movable portion 14 of the ground plane 25 may be an intermediate location between the high permittivity layer 12 and the stationary magnetic sheet 15).

When the current through the actuated coil 26 returns to zero, as shown in FIG. 4, the spring effect of the flexible layer 27 may restore the movable portion 14 of the ground plane 25 to its quiescent position. Thus, the thickness of the air layer 13 and the corresponding air gap 29 may vary according to the current present in the coil 26. The stationary magnetic sheet 15 may also provide a natural stop for the coil 26. Alternatively, the maximum displacement of the coil 26 may be limited by other means before reaching the stationary magnetic sheet 15, such as a fixed, mechanical stop (not shown). In either case, a stopper means for physically limiting variation of the distance between different layers is thus formed. Although the entire flexible layer 27 may move as the coil 26 is actuated and unactuated, the position of the movable portion 14 of the ground plane 25 determines the change in the electrical characteristics of the microstrip line 21, and thus, will be the element referred to in the explanations below.

Thus, the flexible ground plane 25 may include an active, movable portion 14, disposed above the coil 26 and movable through the air layer 13 in a direction perpendicular to the stationary sheet 15, and a region that does not move in a direction perpendicular to the stationary sheet 15. In order to achieve strong electromagnetic coupling between the coil 26 and the stationary magnetic sheet 15, the distance between the high permittivity layer 12 and the stationary magnetic sheet 15 may preferably cover ranges of about 10 μm to about 10 μm, about 100 μm to about 1 μmm, or about 250 μm to about 750 μm. In addition, as illustrated in FIGS. 2 and 3, the range of movement of the movable portion 14 of the ground plane 25 may be increased by the addition of slots 24 surrounding the coil 26 and defining at least two sides of the movable portion 14 of the ground plane 25, although the high permittivity layer 12 may remain continuous. One method of forming the slots 24 entails cutting the flexible ground plane 25 prior to assembly 20 of the device to form the movable portion 14 of the ground plane 25. The dimensions of the slots 24 are such that the edges of the movable portion 14 of the ground plane 25 do not contact the edges of the flexible ground plane 25 disposed on the opposing side of the respective slot 24. The dimensions of the slots 24 also allow the movable portion 14 of the ground plane 25 to be easily movable within 25 the air layer 13. The maximum length and width of the slot 24 may preferably be about 100 mm and about 10 mm, about 10 mm and about 1 mm, about 100 μm and about 10 μm, or about 10 μm and about 1 μm, respectively.

During actuation of the movable portion 14 of the ground plane 25 (i.e. passing current through the coil 26) or de-actuation of the movable portion 14 of the ground plane 25, the thickness of the air gap 29 between the high permittivity layer 12 and the movable portion 14 of the ground plane 25 varies. The variation of thickness of the air gap 29 produces a corresponding variation of the effective permittivity seen by the signals traveling along the microstrip feedline 21. The variation of the effective permittivity results in a corresponding variation in the time delay for the signals propagating through the microstrip feedline 21 to and from the patch antenna 22 or other external elements such as a fixed impedance (transmission) line (not shown).

Specifically, when the movable portion 14 of the ground plane 25 is in contact with the high permittivity layer 12, the effective permittivity seen by the fields propagating through the microstrip feedline 21 may be at a maximum as the fields may see only the permittivity of the solid dielectric of the high permittivity layer 12. This leads to the phase velocity of signals in the microstrip feedline 21 being minimized. Correspondingly, when current passes through the coil 26, the movable portion 14 of the ground plane 25 may be pulled away from the high permittivity layer 12 and the air gap 29 formed between the high permittivity layer 12 and the movable portion 14 of the ground plane 25. The air gap 29 allows the signals see a combination of the permittivity of the high permittivity layer 12 and the permittivity of the air gap 29. More specifically, the effective permittivity varies as a function of the thickness and permittivity of the air gap 29 and the thickness and permittivity of the high permittivity layer 12. Because the permittivity of the air gap 29 is lower than that of the high permittivity layer 12, the effective permittivity seen by the signals is thus lowered when an air gap 29 exists between the movable portion 14 of the ground plane 25 and the high permittivity layer 12, thereby increasing the phase velocity and decreasing the time delay along the microstrip feedline 21.

By using a high permittivity layer 12 with a moderately high permittivity, a ratio of maximum to minimum phase velocity of at least about 1.5 (and up to about 4 or greater) in the section of microstrip feedline 21 above the movable portion 14 of the ground plane 25 may be achieved. As the distance the signals travel through the section of microstrip feedline 21 above the movable part of the flexible ground plane 14 remains constant, the time delay of the signals varies inversely with the phase velocity. The time delay achieved by this device is very linear and is generally constant with frequency, which permits the device to be used in very broad bandwidth applications.

An example of a device using a microstrip feedline printed on 0.5 mm thick alumina, which has a dielectric constant of 9.4, shows that when unactuated (i.e. the thickness of the air gap 29 is 0), the effective permittivity is 6.94 and the phase velocity is 1.137×10⁸ m/s, while when actuated such that the thickness of the air gap 29 is 0.5 mm, the effective permittivity becomes 2.12 and the phase velocity becomes 2.06×10⁸ m/s. Thus, the difference in the actuated and unactuated phase velocities is about 8.13×10⁷ M/s, which translates into a time delay shift of about 12 picoseconds, assuming the microstrip feedline above the active region of the ground plane is about 1 mm in length. A plot of insertion phase vs. frequency of electromagnetic waves propagating along the microwave transmission line 11 of the embodiment of FIG. 1 is shown in FIG. 15.

One factor limiting the achievable range of time delay in the preferred embodiment of FIG. 1 may be the mismatch between the characteristic impedance of the microstrip feedline 21 (having the variable time delay) and other elements to which the microstrip feedline 21 is coupled (e.g. the patch antenna 22 in the first embodiment). Increasing the thickness of the air gap 29 increases the characteristic impedance of the microstrip feedline 21. Thus, the minimum impedance of the microstrip feedline 21 occurs when the movable portion 14 of the ground plane 25 is disposed immediately below the high permittivity layer 12 and the maximum impedance occurs when the movable portion 14 of the ground plane 25 is disposed the maximum distance permitted from the high permittivity layer 12. Large deviations of the microstrip feedline 21 impedance from that of a fixed line (not shown) to which the microstrip feedline 21 is connected may result in undesirable reflection of energy. In the example above, the characteristic impedance of the microstrip feedline 21 when unactuated is about 30.2 Ω, and the characteristic impedance of the microstrip feedline 21 when actuated as above is about 82.9 Ω.

Reflections may be minimized by limiting the distance available for the movable portion 14 of the ground plane 25 to move, i.e. the thickness of the air layer 13. This method may be practical and easy to achieve by mechanically adjusting the thickness of the filler material (not shown). Alternatively, the maximum distance that the movable portion 14 of the ground plane 25 moves may be limited to less than the thickness of the air layer 13 by other physical mechanisms. Examples include physical limiters disposed in the filler material that impinge laterally into the air layer 13 between the unactuated movable portion 14 of the ground plane 25 and the stationary magnetic sheet 15 or limiters disposed on the stationary magnetic sheet 15 that impinge vertically into the air layer 13.

The maximum distance that the movable portion 14 of the ground plane 25 moves may also be limited electromagnetically rather than physically. The distance may be constrained by limiting the amount of current flowing through the coil 26, thereby limiting the electromagnetic force pulling the movable ground plane 14 towards the stationary magnetic sheet 15.

However, limiting the motion of the movable portion 14 of the ground plane 25 also limits the difference between the minimum and maximum delay available for the microstrip feedline 21. Thus, it may be more beneficial to directly limit the mismatch between the characteristic impedance of the microstrip feedline 21 and a fixed line rather than limiting the motion of the movable portion 14 of the ground plane 25. In the first embodiment shown in FIG. 1, without using any techniques to mitigate the mismatch between the characteristic impedance of the microstrip feedline 21 and the fixed line (not shown), the ratio of the maximum to minimum phase velocity may only be limited to about 1.5 to 2 without producing excessive reflection. Using the previous example, for instance, the ratio of the phase velocities is about 1.8.

Impedance matching line sections may be used between the fixed line and the microstrip feedline 21 to decrease mismatch. In the embodiment shown in FIG. 6, the characteristic impedance of the active region of the microstrip feedline 30 disposed above the movable portion 14 of the ground plane 25 is matched to the remainder of microstrip feedline 21. In FIG. 6, the very nature of the movable portion 14 of the ground plane 25 may be used to create a decrease in the mismatch. This is to say that an impedance taper may be introduced by the flexing action of the movable portion 14 of the ground plane 25 to reduce the impedance discontinuity and therefore increase the range of motion of the movable portion 14 of the ground plane 25. The impedance taper thus correspondingly may increase the available phase velocity ratio and time delay of the microstrip feedline 21 and effectively increase the phase velocity ratio from about 1.5 to 2, as above, to about 4.

More particularly, as shown in FIG. 6, portions of the active region of the microstrip feedline 30 disposed above the movable portion 14 of the ground plane 25 form the impedance taper. Essentially, three sections of the active region of the microstrip feedline 30 exist: a middle portion 31 and two end portions 32. The middle portion 31 of the microstrip feedline 21 is disposed above a middle section 33 of the movable region 14 of the ground plane 25 that is relatively planar with the stationary magnetic sheet 15. The end portions 32 of the microstrip feedline 21 connect the middle portion 31 of the microstrip feedline 21 with external sections 35 of the microstrip feedline 21 disposed above the unactuated remainder 36 of the ground plane 25, outside the range of the movable portion 14 of the ground plane 25. The end portions 32 of the microstrip feedline 21 are disposed above end sections 34 of the movable portion 14 of the ground plane 25 that vary in distance from the stationary magnetic sheet 15.

The end sections 34 of the movable portion 14 of the ground plane 25 disposed below the end portions 32 of the microstrip feedline 21 may vary from the actuated distance from the stationary magnetic sheet 15, maintained by the middle section 33 of the movable region 14 of the ground plane 25, to the quiescent distance from the stationary magnetic sheet 15 (generally having no air gap or immediately below the high permittivity layer 12) maintained by unactuated portions 36 of the ground plane 25. Although the embodiment of FIG. 6 illustrates that the actuated distance of the movable region 14 of the ground plane 25 is at a minimum and the quiescent distance a maximum, if the quiescent position of the movable region 14 of the ground plane 25 is not immediately below the high-permittivity layer 12, the reverse may be true. In either case, to properly impedance match using this technique requires the tapering length (end portion length) to be of sufficient length to produce the impedance match.

However, although the above impedance matching section requires few if any additional steps to fabricate, as previously discussed, it may be of paramount importance in some applications to minimize loss. In these applications, therefore, minimization of the transmission line length may be essential rather than ease or cost of fabrication. Thus, in another embodiment, shown in FIG. 7, the microstrip feedline 21 may include one active, time variable delay section 41 and two separate active impedance matching sections 42 to produce the impedances sufficient to match the time variable delay section 41 with external elements such as a fixed impedance line 52 or antenna 22. The two impedance matching sections 42 may be disposed adjacent to the time variable delay section 41 on opposing ends thereof. These impedance matching sections 42 may have symmetric impedances or near symmetric impedances and may have the same shape as the time variable delay section 41. Thus, as shown in FIG. 8, the ground plane 50 may contain four sections: a delay section 48 disposed below the time variable delay section 41, two impedance sections 49 disposed below the impedance matching sections 42, and the unactuated remainder 51 of the ground plane 50. The delay section 48 disposed below the time variable delay section 41, similar to the embodiment above shown in FIG. 2, may contain a movable portion 53 of the ground plane 50, slots 44 in the ground plane 50, and an active section coil 46. Correspondingly, the active sections 49 disposed below the impedance matching sections 42 also may contain movable portions 54 of the ground plane 50, slots 45 in the ground plane 50, and an active section coil 47. As above, the active sections 49 may move correspondingly with the delay section 48 to continually match the time variable delay section 41 with external elements such as the sections 52 of the microstrip feedline 21 external to the active regions 41, 42.

The two impedance matching sections 42 of the embodiment shown in FIG. 8 each may have a length of essentially one-quarter wavelength and thus may be short enough so that they do not add appreciably to the time delay of the microstrip feedline 21 compared with the time delay of the time variable delay section 41. For example, an impedance matching section 42 of about 70.7 ohms may be disposed between a fixed line 52 having an impedance of 50 ohms and a time variable delay section 41 having an actuated impedance of about 100 ohms in order to ensure little to no mismatch between the sections.

Alternatively, as shown in FIG. 9, the time variable delay section 75 may contain subsections forming the time delay and the separate active impedance matching sections 76. In this embodiment, the ground plane 85 may contain four sections: a delay section 77 disposed below the main part of the time variable delay section 75, two impedance sections 78 disposed below end sections of the time variable delay section 75 and forming the impedance matching sections 76, and the unactuated remainder 84 of the ground plane 85. The delay section 77 disposed below the main part of the time variable delay section 75, similar to the embodiment above shown in FIG. 2, may contain a movable portion 80 of the ground plane 85, slots 79 in the ground plane 85, and a delay section coil 82. Correspondingly, the two impedance sections 78 disposed below the impedance matching sections 76 also may contain movable portions 81 of the ground plane 85 and an impedance section coil 83. The movable portions 81 of the impedance sections 78 may be independently controllable from the movable portion 80 of the delay section 77. The movable portions 81 of the impedance sections 78 may move in correspondence with the movable portion 80 of the delay section 77 to continually match the time variable delay section 75 with external elements on either end. Unlike the embodiment depicted in FIG. 8 however, in this embodiment, rather than forming three different individual sections with three sets of slots and individual coils, a single pair of slots 79 with three coils 82, 83 may be used to form the time delay device.

Although in the embodiments shown in FIGS. 1-9, the microstrip feedline 21 and the patch antenna 22 are illustrated as being disposed on the same substrate 20, they may also be disposed on different substrates. That is, the microstrip feedline 21 may be terminated and coupled to other antennas or elements. Note that the first embodiments of the invention pertain to a broadband device in which an upper frequency limit may exist for signals traveling through the microwave transmission line 11 as surface waves or undesirable waveguide modes may exist at higher frequencies, thereby increasing losses and draining signal strength from the traveling wave. This upper frequency limit is related to the materials and dimensions of the specific device and is integrally coupled with the desired performance range of the device. For example, as the wavelength of the signals decreases, thinner materials may be used in composite substrate 20 to avoid the existence of any surface waves or lossy waveguide modes. However, maintaining thinner materials is not necessary for the patch antenna 22, in which the signals are not traveling and thus do not lose energy due to radiation via surface waves or waveguide modes. In addition, lines on thicker substrates are easier to fabricate and other losses, unassociated with those due to surface waves or waveguide modes propagation, may be reduced.

In addition, the ground plane 25 may be relatively thin, which provides more time delay with a lower amount of applied current. The ground plane 25 may alternatively be thicker or made of stiffer material, in which case the frequency of response is faster, i.e., after being actuated, the movable portion of a thick ground plane may return to the unactuated position faster than the movable portion of a thin ground plane. In addition, since the movable portion of the ground plane is constantly being actuated and unactuated, a thicker ground plane may increase the lifetime of the material and prevent embrittlement or metal fatigue of the movable portion of the ground plane. However, the increase in response speed may come at the expense of requiring higher power to actuate the movable portion of the ground plane.

Other configurations of the movable portion of the ground plane are also possible. For example, an embodiment of a flap-type ground plane 64, i.e. a moving flap 70 in the ground plane 64, is shown in FIG. 10. The flap 70 in the ground plane 64 may permit more freedom of movement and thus a greater range of time delay than the slotted structure of the embodiments of FIGS. 1-9.

In the embodiment shown in FIG. 10, the microstrip feedline 21 may be formed into a substantially C shaped active section 68 and vertical tails 69. The center vertical section 65 of the C shaped active section 68 may be disposed above the flap 70 of the ground plane 64 and may generally form the variable time delay section (65) of the microstrip feedline 21. The coil 26 may be disposed below the flap 70. The horizontal sections 66 of the C also generally may be disposed above the flap 70 and form the impedance matching sections that match the impedance of the variable time delay section 65 to the impedance of the fixed impedance lines (the vertical tails 69).

The variable time delay section 65 of the microstrip feedline 21 may provide the majority of the time delay seen by the signals propagating along the microstrip feedline 21. In other words, the horizontal sections 66 may be designed to be short enough, as compared with the variable time delay section 65, as to not add appreciably to the time delay of the variable time delay section 65. The horizontal sections 66 (also called impedance matching sections) also may be designed to appropriately match the impedance of the variable time delay section 65 with the impedance of the fixed impedance lines 69. Thus, when actuated, the flap 70 in the ground plane 64 disposed below the variable time delay section 65 of the microwave feedline 21 may be pulled towards (or pushed away from) the stationary magnetic sheet 15. When actuated, the flap 70 in the ground plane 64, and specifically the variable time delay section 65, may be the portion of the ground plane 64 either closest to or farthest from the stationary magnetic sheet 15.

Only one flap exists in the embodiment depicted in FIG. 10, with the sections of the microstrip feedline for time delay and impedance matching all disposed above the one flap. However, similar to the differences between the embodiments illustrated in FIGS. 3 and 8, other embodiments are possible having multiple moving flaps in the ground plane, each for a separate main time variable delay section that is coupled to individual impedance matching sections. Similarly, slots in the ground plane may be used to create the impedance matching sections with a flap used for time delay. Alternatively, as above, individual coils or other actuation mechanisms may be used within the single flap to alter the shape of the flap and produce the appropriate impedance matching sections.

Another embodiment, shown in FIG. 11, may include an active, rather than passive, lower (stationary) sheet 90. Rather than using a stationary magnetic sheet composed of a ferrous material, the lower sheet 90 may be composed of a non-magnetic material with a second coil 91 printed on the sheet. The second coil 91 may be disposed approximately directly below the first coil 26, itself disposed below the movable portion 70 of the ground plane 64, and may pass current independently of current existing in the first coil 26. The second coil 91 may interact electromagnetically with the first coil 26 to exert force on the first coil 26 and thus the movable portion 70 of the ground plane 64. Unlike an embodiment in which the movable portion 70 of the ground plane 64 may only be pulled towards the stationary magnetic sheet 15 by the electromagnetic force generated between the coil 26 and ferrous material 15, in this embodiment, the second coil 91 may electromagnetically push the movable portion 70 of the ground plane 64 away from the stationary sheet 90, as well as pull the movable portion 70 of the ground plane 64 toward the stationary sheet 90. Although FIG. 11 depicts a variable time delay arrangement having a flap as the movable portion 70 of the ground plane 64, an arrangement having a movable ground plane similar to that of FIG. 1 is also possible.

The ability to both push and pull the ground plane in the embodiment shown in FIG. 11 may allow a greater flexibility in design: the quiescent position of the movable portion (flap) 70 of the ground plane 64 may be an intermediate location between the high permittivity layer 12 and the stationary sheet 90, as shown in FIG. 12. Thus, the distance between the quiescent position of the movable portion 70 of the ground plane 64 and the stationary sheet 90 is reduced in the embodiment of FIG. 12, and correspondingly, less power may be necessary to pull the movable portion 70 of the ground plane 64 to the stationary sheet 90 than if the quiescent position of the movable portion 70 of the ground plane 64 was adjacent to the high permittivity layer 12. Further, the loss in a network containing multiple time delay devices embedded within may be minimized if the quiescent position of the movable portion 70 of the ground plane 64 is disposed at an intermediate location between the high permittivity layer 12 and the stationary sheet 90.

Alternately, the quiescent position of the ground plane may be disposed immediately adjacent to the stationary sheet. FIGS. 13 and 14 depict the embodiment of FIG. 12, in which the quiescent position of the movable portion 70 of the ground plane 64 is an intermediate location between the high permittivity layer 12 and the stationary sheet 90, and the first coil 26 disposed on the bottom of the flexible layer 27 is respectively pushed and pulled by the second coil 91 on the stationary sheet 90. Although not depicted, another embodiment exists in which the first coil 26 disposed on the bottom of the flexible layer 27 may be eliminated, leaving the second coil 91 on the stationary sheet 90 to actuate the movable portion 70 of the ground plane 64 (which in turn may have a quiescent position adjacent to the high permittivity layer 12, at an intermediate location between the high permittivity layer 12 and the stationary sheet 90, or adjacent to the stationary sheet 90).

Electromechanical actuation, however, is not the only method of actuation possible. Another embodiment uses piezoelectric actuation. A top view of this embodiment is shown in FIG. 16. The majority of the embodiment shown in FIG. 16 remains similar to the previous embodiments: the high-frequency device 94 may include a microwave transmission line disposed on a composite, multi-layer substrate 95 having at least one printed circuit board. The composite substrate 95 may contain a fixed high permittivity layer 12, a flexible ground plane 96 having a moving flap 97 with a substantially C-shaped section, an air layer (not shown), and a stationary sheet (not shown), all in the vicinity of an active area of the composite substrate 95. In this embodiment, however, the composite substrate 95 contains a ground plane 96 formed with a piezoelectric material and the stationary sheet (not shown) may be composed of any relatively stiff material. In addition, an electrode 98, rather than a coil, may be disposed below the moving flap 97 of the ground plane 96. The electrode 98 may be formed below up to the entirety of the area of the moving flap 97 to formed below essentially only the cantilever portion of the moving flap 97 (connecting the moving flap 97 with the remainder of the ground plane 96). With the electrode 98 formed below the entirety of the area of the moving flap 97, deflection of the moving flap 97 may be maximized when actuated. The electrode 98 may be formed of a conducting material, preferably a metal. The thickness of the piezoelectric layer 96 may range from about 0.05 mm to about 1 mm, preferably about 0.08 mm to about 0.5 mm or about 0.1 mm to about 0.2 mm. For example, a moving flap of about 0.2 mm thickness travels about 1.2 mm.

Other embodiments may use direct mechanical or pneumatic actuation in which the movable portion of the ground plane may be connected to a manifold. Purely mechanical implementations of the direct mechanical actuation may include tuning screw(s), push/pull rod(s), stepper motor(s), servo motor(s) or similar means to directly adjust the movable portion of the ground plane.

In pneumatic actuation using a manifold, the manifold may contain pressurized air or hydraulic fluid, either of which may be used to push the movable portion toward the high permittivity layer or towards the stationary layer. If multiple devices exist in a network, the movable portions in all of the devices may be connected to a single manifold and pushed up or down in concert. Alternatively, a number of manifolds may exist, each of which controls the movable portion of one or more devices, rather than one manifold controlling all of the movable portions of all of the devices. Thus, variable time delay devices in a beamformer, for example, may use manifolds to provide the ability to control either all or a set of the devices present in a network.

Advantages of using mechanical or pneumatic actuation may include both simplicity of design and actuation as well as a decrease in, or the elimination of, power required to actuate the device (depending on the embodiment used). Embodiments using these methods of actuation, however, may have a slower response than actuation via an electromechanical mechanism. Thus, applications in which only one-time tuning (e.g. during manufacturing) is required or a quick speed of response is not necessary may use mechanical or pneumatic actuation. For applications in which only one-time tuning is required, the ground plane may be composed of a soft, deformable metal which may be permanently bent and provide a permanent and constant time delay.

Electrostatic methods may also be used to actuate the high-frequency device. In a micro-electromechanical system (MEMS) capacitor structure, for example, a flexing leg may be moved relative to a fixed point having a charge by applying voltage to the flexing leg. The movement may depend on the amount and polarity of charge supplied to the flexing leg; the flexing leg may be pulled towards the fixed point if they have opposite electrostatic charges and may be pushed apart if they have like electrostatic charges. Thus, the pull exerted on the movable portion of the ground plane by the stationary sheet may be proportional to the amount of charge on the movable portion of the ground plane and the direction of movement of the movable portion of the ground plane may be dependent on the polarities of the charge on the movable portion of the ground layer and the stationary sheet. The electrostatic force, may be weaker than the electromagnetic force but may have very low power requirements. In embodiments using electrostatic actuation, it may be necessary to charge the ground plane, but once the movable portion of the ground plane is charged, the same force may be exerted indefinitely on the movable portion of the ground plane so long as the charges do not leak away. Thus, very little or no current may be required to maintain actuation.

An alternate embodiment of the electrostatic actuation method may include charging only the movable portion of the ground plane rather than the entire ground plane. As the movable portion of the ground plane may move to alter the electrical characteristics seen by the signals propagating along the microstrip feedline, the remainder of the ground plane may be isolated. This may allow charging of only the movable portion of the ground plane rather than the entire ground plane and thereby decreases the total amount of charge required to produce movement of the movable portion of the ground plane.

The above embodiments may be either digitally controlled or use analog control. Using analog control, in general, the amount of current or voltage controls the amount of flexing of the movable portion of the ground plane and thus the amount of delay through the device. An analog device may thus be formed by an analog controlling means for continuously controlling an amount of delay of the variable time-delay circuit. However, while the analog-controlled devices have numerous advantages, including minimum RF loss and infinite delay resolution as described above, they also are susceptible to current and/or voltage variation, aging of components, and environmental factors. Digitally controlled devices, on the other hand, may be less vulnerable to these factors but may not retain the resolution of analog-controlled devices. These devices thus include a digital controlling means for incrementally controlling an amount of delay of the variable time-delay circuit.

A single digitally controlled device (single-bit device), for example, may have only two states: un-actuated and fully-actuated. Thus the digital control signal may correspond to either a “0 or a 1”, where one of these states causes full deflection of the movable ground plane. The control signal may be applied to a D/A converter (with or without a subsequent amplifier) and the corresponding current or voltage used to actuate the movable portion of the flexible ground plane may be larger than the minimum amount necessary for full deflection in order to make the actuation less susceptible to current or voltage noise.

In addition, variable time-delay circuits may use more than one digitally controlled device, arranged in a cascade fashion—cascaded within a monolithic structure, to achieve incremental changes in time delay (similarly, multiple analog-controlled devices may be cascaded). For example, one such circuit may use multiple single-bit devices having identical characteristics/time delays. In another embodiment, multiple single-bit devices having different time delays may be used in which the time delays are altered by varying the lengths of actuated transmission line. Alternatively, the time delays of the single-bit devices may be changed by mechanically limiting the deflection using a fixed stop, as described above. In the latter case, different single-bit devices may have fixed stops that allow different amounts of deflection.

In one example, a 4-bit delayer may be formed by cascading four single-bit digital devices as follows: a first device with relative delay states of “0” and “d” seconds; a second device with relative delay states of “0” and “2d” seconds; a third device with relative delay states of “0” and “4d” seconds; and a fourth device with relative delay states of “0” and “8d” seconds. This delayer may thus be capable of any delay between 0 and 15 d seconds, with a resolution of d seconds. This can obviously be extended to create digital delayers with any number of bits.

Other embodiments include using numerous transmission line types in place of the microstrip transmission line in the embodiments described above. The other transmission lines may include a stripline transmission line, a coplanar waveguide transmission line, a rectangular waveguide transmission line, as well as other comparable waveguides.

In addition, potential applications for the embodiments described and/or depicted include devices that use a variable time delay, e.g. a variable time delay line, a variable capacitor, tunable antennas or filters, tuning stubs, and an electronically controlled beamformer for a phased-array antenna (controllers for reconfigurable/smart antennas). For example, the electronically controlled beamformer may be created by inserting one or multiple copies of the variable time delay device in the branches of a power divider and individually controlling them. In this case, the time delay from the input to any output port in the beamformer can be controlled. If the output ports of the beamformer are connected to radiating antenna elements, an electronically steerable, or phased array antenna may be created. This implementation may create a true-time-delay beamformer, with an important advantage that the beam steering angle may be constant over a very broad band of frequencies.

One basis for one embodiment of such a beamformer is that multiple, controlled, time delay components may be distributed into a fractal RF feed network, and the main beam may be scanned by applying only a very limited number of unique control signals. To understand how such a beamformer operates, the nature of a fractal tree first must be understood. For background on fractal trees, the reader can consult the following reference: Douglas H. Werner, “The Theory and Design of Fractal Antenna Arrays,” chapter 3 of Frontiers in Electromagnetics, edited by Douglas Werner and Raj Mittra, IEEE Press, 2000. In this work, the authors introduce fractal trees, and teach various methods of designing fractal based antenna arrays in terms of the antenna element locations and excitations. However, in this reference, methods of beam scanning and details of feed networks are not addressed.

Fractal trees can be built by starting with an initiator 1000 and, in each stage, attaching a generator 108 to the end of each branch of the tree. The embodiments of FIGS. 17-28 may be of the type disclosed in application serial number 09/863,975 entitled “Planar, Fractal, Time-Delay Beamformer,” filed May 23, 2001 in the names of William E. McKinzie, III and James D. Lilly, which is commonly assigned with the present application and in incorporated herein by reference in its entirety.

FIG. 17 is an example of a deterministic fractal tree created by repeatedly applying a properly scaled generator 108 to the tips 104 of the branches 102 of the initiator 100. In each subsequent stage, the generator 108 is reduced in linear dimensions by a factor of 0.5. Other scale factors could also be used. Building a fractal tree is a recursive process in which the n+1st stage is created from the n^{th} stage by repeatedly attaching scaled generators 108 to the ends of the nth tree's branches. In the illustrated example, the generator is applied to the tips 112 of the branches 110 of the previously most extreme generators 108 from the initiator 100. This example is called a linear fractal tree since the tips of the branches of the tree form a linear geometry. Three stages of growth are shown. The initiator 100 alone is referred to as stage 0.

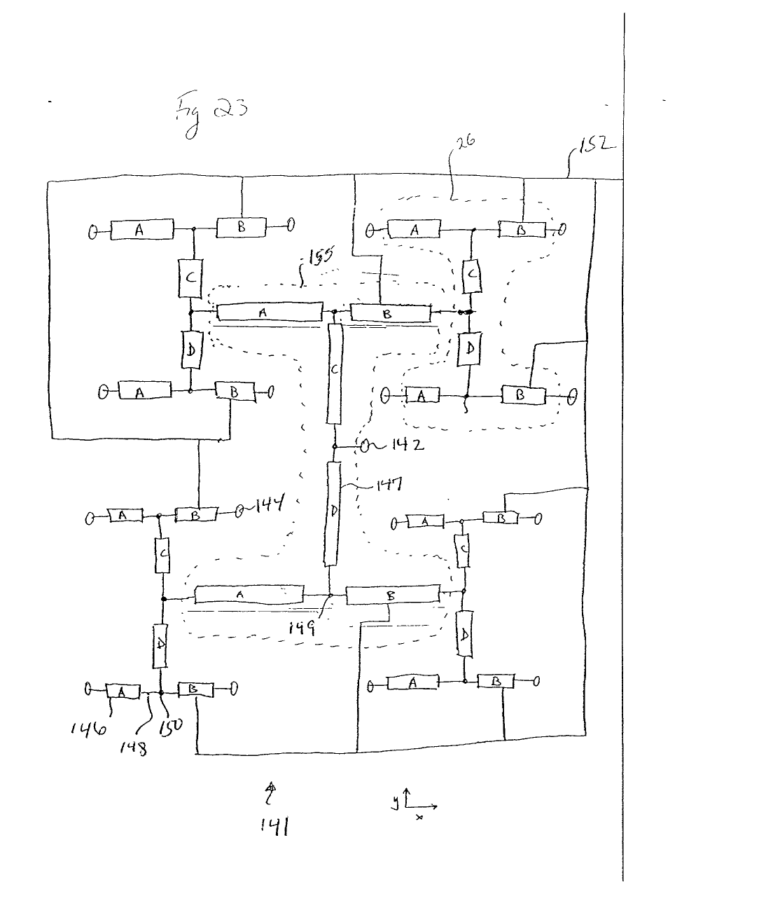

In another example shown in FIG. 18, a deterministic fractal tree is created by repeatedly applying a properly scaled generator 120 to the tips 124 of the branches 122 of the initiator 128. In each subsequent stage, the generator 120 is reduced in linear dimensions by a factor of 0.5. This is called a square fractal tree since the tips 124 of the branches 122 of the generator 120 form a square. Three stages of growth are shown. However, an infinite number of stages is conceivable. In this example, as the initiator 128 and generator 120 are identical except for scale, they are said to be self-similar. In general, the initiator 128 and generator 120 do not need to be self-similar. Furthermore, although the scale factor is not limited to 0.5, if it is not, the tips 124 of the branches 122 will not be uniformly spaced. The design of an antenna array is simplified if uniform spacing is assumed.

For the examples shown in FIG. 18, the stage 1 tree offers a square 4×4 array of beamformer outputs, while the stage 3 tree offers a square 16×16 array of outputs. These two examples of feed networks are also known as corporate feed networks. However, because not all fractal feed networks can be described as a classic one dimensional or two dimensional corporate feed network, the concept of fractal trees has been introduced to describe the most general case.

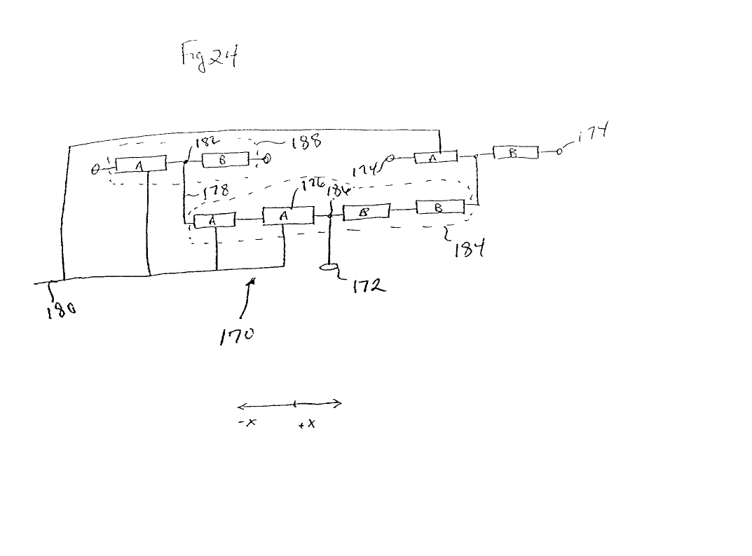

In one embodiment, a 4×4 time-delay beamformer that is steerable in two dimensions is illustrated in FIG. 19. The beamformer 140 may have a single common input port 142, sixteen output ports 144, and a plurality of transmission line delay elements 16, arranged in a generator pattern. The generator pattern is a replicated pattern containing an initiator pattern 154 and generator patterns 156 that are self-similar, albeit physically and electrically smaller than, the initiator pattern 154.

In this embodiment of a fractal feed network, the generator pattern 156 has electrical dimensions one-half the size of the initiator pattern 154. Subsequent replications of the generator pattern 156 are smaller by another factor of one-half. Transmission lines 148 connect the delay elements 146 with each other and with the input port 142 or output ports 144. The output ports 144 are connected with radiating elements of an antenna. The electromagnetic signals transmitted at the output ports 144 have a maximum wavelength of transmission. Thus, the output ports 144 are spaced between about 0.4 to about 0.8 of the maximum wavelength apart. T junctions 149, 150 or T intersections of the transmission lines 148 form multiple corporate power dividers, which divide the power of the signal into either equal or unequal parts as desired.

The delay elements 146 may be integrated within the printed fractal feed network, producing an integrated, planar true time-delay (rather than phase delay) beamformer 140. Any of the embodiments of described herein or other suitable embodiments may be used to form the delay elements. The transmission lines 148 may be constructed from any material having a large bandwidth and that allows signals to propagate with low loss. Typical transmission lines may be microstrip, stripline, coplanar waveguide, or other technologies that employ conductors such as copper, aluminum, silver, gold, or a comparable alloy.

The controllable delay elements 146 of the present invention delay or enhance the propagation of an electromagnetic signal in time, rather than shifting the phase of the signal during propagation. The delay element 146 is a broadband element that provides a constant time delay independent of the signal frequency over a broad range of frequencies. Examples of the range of frequencies over which the time delay of the delay element 146 remains substantially constant may include one or more octaves in the microwave or millimeter wave frequency regime. The pointing angle of the electromagnetic gain pattern from the beamformer 140 may correspondingly remain constant over a wide range of frequencies, thereby permitting its use in broadband or multi-frequency arrays. The delay elements 146 thus may not limit the range of constant delay of the beamformer 140. For example, either the bandwidth of radiating elements connected with the output ports 144 or the physical spacing of the output ports 144 may limit this range. In the latter case, if the physical spacing of the output ports 144 is greater than about 0.8 of the free space wavelength of the radiated signal, grating lobes may be formed, while if the physical spacing of the output ports 144 is less than about 0.3 of the wavelength of the radiated signal, efficient antennas may not be formed.

The delay elements 146 may be fabricated on a printed circuit board using conventional processes and thus may be integrated with the remainder of the array elements. Creation of the beamformer 140 by monolithic fabrication may eliminate the need for separately packaged, expensive, and RF-active components such as phase shifters and lower the cost of fabricating the array. Thus, the addition of such time delay components may result in a thin, low cost array without drop-in or RF-active devices i.e. no amplifiers or other active components. By using monolithic integration rather than discrete components, impedance mismatches between the delay elements 146 and the transmission lines 148 may be decreased, correspondingly decreasing the amount of reflection between the two components, and thereby may result in lower RF losses.

In addition, because the beamformer 140 in such an embodiment is planar, the length of transmission line 148 between the input port 142 and any output port 144 may be minimized. This may further decrease loss through the beamformer 140 and permit the RF-passive beamformer 140 to be used for some applications. The planar beamformer 140 may be integrated with printed-circuit antenna elements such as patches, which may be fabricated on the same substrate as the beamformer 140. The antennas may also be fabricated on other layer(s), which may be laminated to the beamformer 140 or combined with the beamformer using standard PCB processes, and interconnected to the beamformer 140 using printed-circuit vias, z-wires, or coupling slots, for example. Thus, an entire, functional phased array may be fabricated in a printed-circuit process, using one or multiple layers.

The delay elements 146 may have a time delay that is controlled via a control signal on a control line 152. The control signals on control line 152 may be set by a microprocessor or other control circuit (not shown) and optimize the pointing direction of the beam formed by the electromagnetic signals emitted by the radiating elements. The time delay of each delay element 146 may be continuously variable, incrementally variable, permanently set after being varied for the first time, or infrequently adjusted on an as-needed basis.

The control signals on control line 152 may be analog-based signals or digital-based signals. The analog signals may be current or voltage control signals that continuously vary the time delay of a particular delay element 146. For example, the delay element 146 may consist of at least one variable time delay transmission line segment whose time delay from one end to the other is set by the control signal on control line 152. In this example, the time delay through the delay element 146 may be adjustable by controlling the shunt capacitance of the delayer's transmission line model. Furthermore, the shunt capacitance may be reduced when a non-zero bias voltage is applied. Such is the case for some varactor-tuned transmission lines. The phase delay of a signal traveling from one end to the other end of the transmission line segment is given approximately (in the linear regime of variation) by:

$$θ \approx {β}_{0} L ( 1 - \frac{{mX}_{bias}}{2 {C}_{0}} )$$

where:

θ=phase delay,

$${β}_{0} = \frac{2 π}{λ} = phase constant of the unbiased transmission line segment ,$$

λ=wavelength of the electromagnetic signal propagating through the transmission line segment,

L=length of the transmission line segment,

C₀=capacitance/unit length of the unbiased transmission line segment, and

m=slope of the capacitance vs. amount of bias curve

X_{bias}=amount of bias applied to the transmission line segment (X may be either I=current or V=voltage)

In the above mathematical example for the delay element 146, the time delay is reduced when a non-zero bias signal is applied. However, the delay element 146 may have a time delay response such that the insertion delay is increased upon application of a bias voltage or current.

Alternatively, digital signals may be used to incrementally change the time delay between the input and output of the delay element 146. In one embodiment, shown in FIG. 20, a delay element 146 may have a plurality of generator patterns 160 connected in parallel, with each generator pattern 160 having a pair of normally open, single-pole switches 164 or switching devices connected in series with a delayer 162, each delayer 162 having a different preset time delay. A pair of normally open switches 164 are used as any generator patterns 160 that remain connected will be a reactive load to the transmission line at the location where they are still connected, thereby exacerbating the return and insertion loss of the delayer 162.

As further illustrated in FIG. 20 the digital signal on a line 152 may control a multiplexer 166 that closes associated pairs of the switches 164 and thus selects one of the delayers 162 to act as the overall time delay across the delay element 146. Alternatively, as shown in FIG. 21, each delay element 146 may have a plurality of delayers 162 with either the same time delay or different time delays connected in series. The digital signal on line 152 controlling the multiplexer 166 may then actuate from none of the delayers 162, corresponding to no time delay, to all of the delayers 162, corresponding to maximum time delay, to form the overall time delay across the delay element 146. The switches 164 (FIG. 20) may be PIN diodes, MOSFETS, BJTs, MESFETs or any other type of transistor or switching element known in the art of electronic switching, including switches such as MEMS-based RF switches. The multiplexer 166 may be implemented using digital logic, analog circuitry or in any other manner known in the art of multiplexing electronic signals.

As FIG. 19 shows, the fractal feed network of the illustrated embodiment contains an initiator pattern 154 and generator patterns 156 that are self-similar to the initiator pattern 154. In one embodiment of the fractal tree, the initiator pattern and generator patterns are self-similar, i.e. they have the same shape only scaled in linear dimensions. The generator patterns 156 have a similar number and formation of T intersections 150 of the transmission lines as the initiator pattern 154. However, individual generator patterns 156 may have a different number of delay elements 146 from either the initiator pattern 154 or subsequent stages of generator patterns 156. For example, in the first embodiment of the present invention, the number of delay elements 146 between transmission line intersections 149 in the initiator pattern 154 is twice that of the number of delay elements 146 between the corresponding transmission line intersections 141 in each generator pattern 156. In addition, in the first embodiment, the initiator pattern 154 is symmetric around the input port 142. That is, the transmission line intersections 149 are symmetrically arranged around the input port 142 and the same number of delay elements 146 exist between each transmission line intersection 149. Similarly each generator pattern 156 is identical to the other generator patterns 156, the generator patterns 156 are symmetrically arranged, and, as in the initiator pattern 154, the same number of delay elements 146 exist between each transmission line intersection 141 in each generator pattern 156.

Other advantages of using the embodiment illustrated in FIG. 19 may originate from the individual delay elements 146 being identical. By using identical delay elements 146, the beamformer 140 may be easier to design and fabricate and may have a lower cost (if discrete components are used). Further, the linearity and response performance of the beamformer 140 may be improved when using identical delay elements 146. This may be especially important for a beamformer 140 having a large number of delay elements 146.

The delay elements 146 are thus distributed throughout the generator pattern rather than being lumped near the output ports 144. Because of the distribution of the delay elements 146, fewer control signals on the control 152 are necessary to control the direction of the signal emitted from the beamformer 140, i.e. to scan the beamformer 140 in one or more directions as one control signal on the control line 152 controls multiple delay elements 146. In one case, the number of unique control signals 22 controlling the delay elements 16 may be about the number of principal plane directions (+x axis, −x axis, +y axis, −y axis) in which scanning may occur. For example, only four unique control signals are needed to scan the beam in both the xz and yz planes as formed by the beamformer 140. Furthermore, for general two-dimensional beam steering, only two of these four control signals must be nonzero.

The quantity of delay elements 146 in the beamformer of FIG. 19 may be calculated using a simple mathematical expression. In general, for a 2ⁿ×2ⁿ square array, the number of delay elements 146 is given by 3*(2²ⁿ−2ⁿ), where n is a natural number indicating one-half the number of beamformer outputs in each row. Thus, for a 4×4 array, n=2, and the number of equal length delay elements 16 is 3*(2⁴−2²)=36.

In the embodiment shown in FIG. 19, for example, one unique control signal on the control line 152 controls about ¼ of the total delay elements 146. Only four control signals may thus be used to control thirty-six delay elements 146: six on each of the four generator patterns 156 and twelve in the initiator pattern 154. In FIG. 19, all of the delay elements 146 denoted by same letter are connected with and controlled by the same unique control signal 152. For example, all of the delay elements 146 denoted the letter “A” may be activated at the same time and with the same bias amplitude to produce the same delay. Only one of the control signals of the control line 152, the control signal controlling “B” delay elements 146, is shown for clarity in FIG. 19. Thus, the application of only four delay settings, i.e. control signals 152, yields scanning of the beam formed by the beamformer 140 independently in both x and y (or θ and φ directions. Numerous advantages occur from decreasing the number of control signals of the control line 152 including low packaging volume of the beamformer 140, lower power requirements, and the elimination of dense control wiring. Further, a complex antenna control unit (microprocessor) including software programs may not be necessary to control all of the delay elements 146 individually.

For example, in the embodiment shown in FIG. 19, if the bias applied to all of the delay elements 146 is identical, no scanning is possible and a broadside beam results. However, if at least one set of delay elements 146 has a non-identical bias signal applied, scanning of the beam off broadside is realized. In one example, all of the delay elements 146 denoted “B” are set to a delay of one time unit (relative to an arbitrary reference delay) and all other delay elements 146, sets “A”, “C” and “D”, are set to have no relative delay. Tracing the signal paths through the beamformer 140 from the input port 142 to the different output ports 144, one sees that there is no relative time delay at the leftmost column of output ports 144, as none of the delay elements 146 through which the electromagnetic signal passes are activated. For example, from the input port 142 to the output port 144₁₂, the electromagnetic signal passes through two “D” delay elements 146, two “A” delay elements 146, one “C” delay element 146, and another “A” delay element 146, none of which have a relative delay. Continuing, the relative time delay at the next leftmost column of output ports is one time unit as the electromagnetic signal must pass through one “B” delay element; the relative time delay at the next rightmost column of output ports is two time units, and the relative delay at the rightmost column of output ports is three time units. This situation results in a beam scanned in the “+x” direction of the xz plane by virtue of progressive time delays for each column of beamformer output ports. For the sake of clarity, only the leftmost column of output ports 144, are shown in FIG. 19.

Similarly, if the all of the delay elements 16 denoted “C” are set to a delay of one time unit, with the remaining delay elements unbiased, there is no relative delay at the lowermost row of output ports, the relative time delay at the next lowermost row of output ports is one time unit, the relative time delay at the next to highest row of output ports is two time units, and the relative time delay at the highest row of output ports is three time units. This situation results in a beam scanned in the “+y” direction of the yz plane.

FIG. 22 shows a table of biases (X) applied to the four different sets of delay elements 146 of FIG. 19 and the resultant scanning direction created. A 1 or a 0 in this table indicates the presence or absence, respectively, of a nonzero biasing signal. Of course, scanning may be either continuous or discontinuous in any particular direction. Furthermore, this table assumes that the time delay is increased when the delay elements are biased. If one employs a type of time delay element whose insertion delay decreases with applied bias voltage, then the beampointing directions will be reversed or rotated by 180° in azimuth.

Another, slightly different embodiment of a beamformer is shown in FIG. 23. Whereas in the first embodiment, shown in FIG. 19, all of the delay elements 146 were similar in that they had equal ranges of time delays, in the second embodiment of the beamformer 141 of FIG. 23, the delay elements 147 in the initiator pattern 155 have twice the range of the delay of the corresponding delay elements 146 in the generator patterns 156. However, compared to the first embodiment of FIG. 19, only half the number of delay elements 147 are used in the initiator pattern 155 of the second embodiment. The resulting time delay profile of the beamformer 141 of the second embodiment is thus identical to the time delay profile of the beamformer 140 of the first embodiment. One advantage of using fewer devices to achieve the same time delay profile is a decrease in mismatch loss caused by possible impedance mismatch between the delay elements 147 and the transmission lines 148. If discrete delay elements 147 are preferred rather than integrated devices the cost of the beamformer may be correspondingly reduced with the number of delay elements 147.

Yet another embodiment of a planar fractal feed network (not shown) is a fractal tree similar to that illustrated in FIG. 19. In this embodiment, only a portion of the delay components are present, the portion required for one-dimensional beam steering. For instance, in the embodiments of FIGS. 19 and 23, if delay elements 146 denoted as “A” and “B” remain, but delay elements 146 denoted as “C” and “D” are removed, then the beam scanning will be limited to the xz plane.

The beamformers in the above embodiments may be extended for use with antenna arrays of any size or number of delay elements. Through recursion, an 8×8 beamformer (for a 64 element array) may be designed which consists of four of the circuits shown in FIG. 19, interconnected by another power divider 154 that is twice as large as the larger power divider shown, and having four delayers in each arm. This would be a stage 3 fractal tree.

The power division of the T junctions 149, 141 is not necessarily an equal split; an unequal split may also be created. If the power division is equal, a uniformly illuminated array results. By using unequal power division in some of the T junctions, an amplitude taper may be applied to the array, which reduces sidelobe levels of the resulting antenna pattern. Unequal split may also be used to create arrays that are not square in shape [i.e. do not have 3*(2²ⁿ−2ⁿ) delay elements, where n is a natural number], or which have a non-even number of elements.

In another embodiment, illustrated in FIG. 24, the beamformer 170 may be configured to support one-dimensional scanning of a linear array. In FIG. 24, one input port 172, four output ports 174, three T junctions 182, 186, eight identical delay elements 176, and transmission lines 178 linking these components are present. As in the two-dimensional structure, the eight delay elements 176 are distributed between an initiator pattern 184, which has four delay elements 176, and two generator patterns 188, which-have the other four delay elements 176. All of the delay elements 176 are aligned in the same linear direction. Of the eight delay elements 176, one set of four are controlled by a first control signal on a control line 180 and denoted “A,” and the other set of four are controlled by a second control signal and denoted “B”. The control signal for the elements labeled “B” is not shown in FIG. 24 so as not to unduly complicate the drawing figure. Each control signal 180 will uniformly adjust the time delay in delay elements denoted as “A” which allows the antenna pattern to be scanned in the xz plane. The generator patterns 188 are identical, each having a single delay element 176 controlled by the first control signal on one side of the T junction 186 forming the generator pattern 188 and a single delay element 176 controlled by the second control signal on the other side of the T junction 186 forming the generator pattern 188. The generator patterns 188 are symmetrically disposed around the ends of the initiator pattern 184. The initiator pattern 184 has two delay elements 176 controlled by the first control signal on control line 180 on one side of the T junction 182 forming the initiator pattern 184 and a two delay elements 176 controlled by the second control signal on the other side of the T junction 182 forming the initiator pattern 184.

The manner in which the feed network for the linear array operates is similar to the manner in which the two-dimensional fractal tree operates. The linear beamformer 170 may be operated in a broadside mode, in which none of the delay elements 176 are actuated, or may be scanned in either the +x or −x direction of the xz plane. For example, to actuate the linear beamformer 170 such that the main beam points in the −x direction (to the left in FIG. 24), the delay elements 176, denoted as “A”, connected with the first control signal 180 may be actuated, while the delay elements 176, denoted as “B”, connected with the second control signal remain unactuated. In this example, actuating the delay element means the time delay is increased. In this case, electromagnetic signals introduced from the input port 172 into the linear beamformer 170 would suffer no relative delay in reaching and being emitted from the rightmost output port; a relative delay of one unit in reaching and being emitted from the next rightmost output port; a relative delay of two units in reaching and being emitted from the next leftmost output port; and a relative delay of three units in reaching and being emitted from the leftmost output port.

Alternatively, as in the two-dimensional array, rather than having a pair of delay elements 176 disposed on either side of the T junction 182 of the initiator pattern 184 with each delay element 176 identical to those in the generator patterns 186, a single delay element 176 having twice the delay may replace one or both of the pair of delay elements 176 on each side of the junction 182.

A planar array may be composed of vertically-disposed columns of antenna elements, each column being fed at one end by one output port of a fractal feed network. A planar beamformer with a number of output ports equal to the number of columns may be configured to feed the columns, resulting in an array with one-dimensional beam steering. Such an array may have a fixed elevation beam, which may be steered in azimuth. This embodiment may have cost, size, and efficiency advantages relative to two-dimensional beamformers.

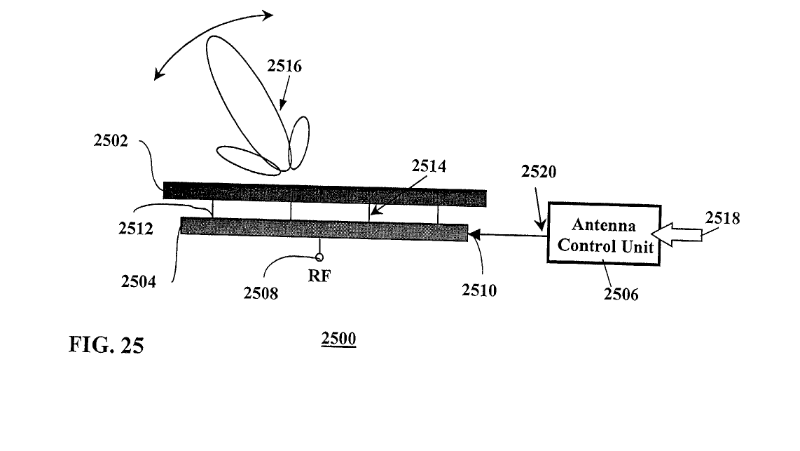

FIG. 25 illustrates one embodiment of an antenna system 2500. The antenna system 2500 includes a printed array 2502 of radiating elements, a beamformer 2504 and an antenna control unit 2506. The beamformer 2504 includes a feed port 2508 configured to receive a radio frequency (RF) signal for transmission by the antenna system 2500, or to provide a detected radio frequency signal received by the antenna system 2500. The beamformer 2504 further includes a control port 2510 configured to receive two or more control signals from the antenna control unit 2506. The beamformer 2504 may be manufactured and operated in accordance with any of the embodiments disclosed herein or with any other suitable embodiment. Preferably, the beamformer 2504 includes a two-dimensional arrangement of output ports and variable time-delay transmission line segments integrated within a printed corporate feed network, to produce an integrated, planar true-time-delay beamformer. The beamformer further includes output ports 2512 configured to be coupled with the printed array 2502. The time delay from the feed port 2508 to individual output ports 2512 is controlled by the time-delay elements of the beamformer, under control of the control signals received at the control port 2510 from the antenna control unit.

The printed array 2502 includes an array of radiating elements. These elements may be radiating patch antennas, or any other suitable radiator. The radiating elements are fed from RF connections 2514 coupled with the output ports 2512 of the beamformer 2504. In combination with the beamformer 2504, the radiating elements of the printed array 2502 form a beam which may be scanned or pointed to a variable pointing direction under control of the antenna control unit 2506. The antenna control unit 2506 is coupled with the beamformer 2504 to steer the beam 2516 of the antenna system 2500. The antenna control unit in the illustrated embodiment of FIG. 25 is coupled with a digital data bus 2518 to receive data and instructions for controlling the beam 2516. The antenna control unit 2506 may include any appropriate circuitry, including logic devices, memory, and analog devices suitable for translating a digital signal on a digital bus 2518 to the appropriate bias control lines at an output port 2520 for controlling the beamformer 2504. The output port 2520 is coupled with the control port 2510 of the beamformer. The control signals provided at the output port 2520 may be analog signals or digital information.

In one embodiment, the planar beamformer 2504 is integrated with the printed array 2502 of antenna elements. The antenna elements may be fabricated on the same substrate as the beamformer 2504, or on other layers which may be laminated to the beamformer 2504 and interconnected with the beamformer using, for example, printed circuit vias, z-axis wires, or coupling slots. Thus, the entire functional phased array in one embodiment is fabricated using a printed circuit process, using multiple layers.

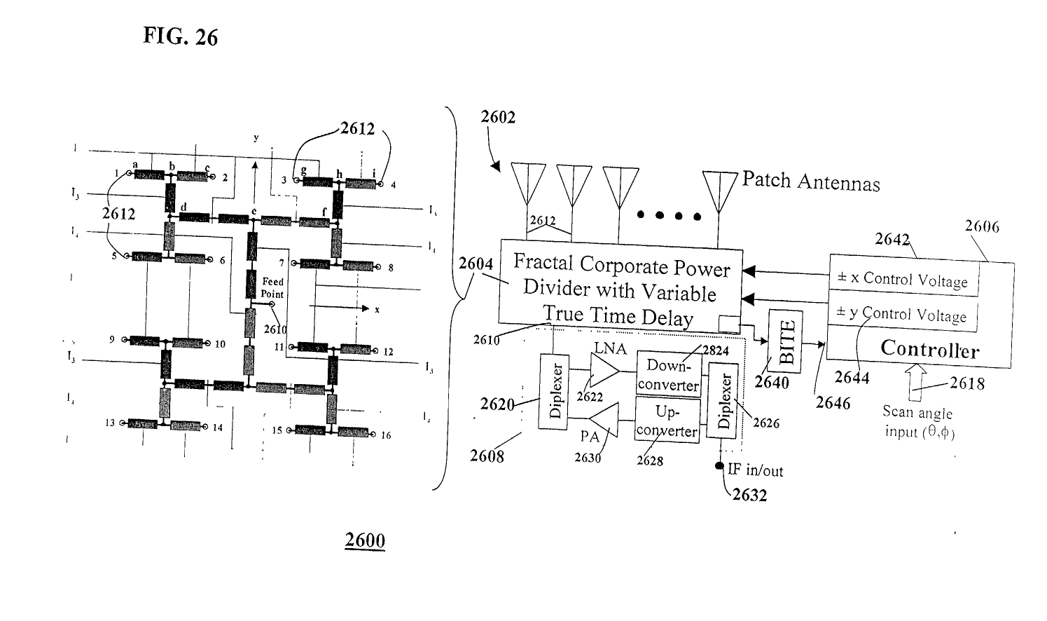

FIG. 26 is a second embodiment of an antenna system 2600. The antenna system 2600 includes radiating elements 2602, a beamformer 2604 and a controller 2606. The antenna system 2600 further includes a radio frequency to intermediate frequency (RF to IF) section 2608.

The radiating elements 2602 in the embodiment of FIG. 26 are dual-band patch antennas. Other radiating elements may be used instead. The beamformer 2604 comprises a fractal corporate power divider with variable true time delay and may be embodied as shown to the left in FIG. 26. The beamformer 2604 includes a feed port 2610 and output ports 2612 coupled with the dual-band patch antennas or radiating elements 2602.

The RF to IF circuit 2608 includes a diplexer 2620, a low noise amplifier 2622, a down-converter 2624, a diplexer 2626, an up-converter 2628 and a power amplifier (PA) 2630. The RF to IF circuit 2608 receives an intermediate frequency signal at an IF port 2632. The intermediate frequency signal is provided to the up-converter 2628 increased in frequency to the radio frequency required for transmission, amplified in the power amplifier 2630, and provided through the diplexer 2620 to the feed port 2610 of the beamformer 2604. For reception of radio frequency signals, the RF to IF circuit 2608 receives a radio frequency signal from the feed port 2610 of beamformer 2604 through the diplexer 2620. The received signal is amplified and possibly filtered in the low noise amplifier 2622, and reduced in frequency to an intermediate frequency (IF) in the down-converter 2624. The IF signal is provided through the diplexer 2626 to the IF port 2632. The RF to IF circuit 2608 may further include a signal generating circuit, such as a phase-locked loop and oscillator for generating local oscillator signals to control the up conversion and down conversion in the RF to IF circuit 2608.

The controller 2606 is configured to provide control signals to the beamformer 2604 to steer an antenna beam associated with the antenna system 2600. The controller receives a digital signal on a digital bus 2618 and provides control signals to the beamformer 2604. The control 2606 includes an x control section 2642 and a y control section 2644. The x control section generates the necessary control signals to steer the beam in a plus or minus x direction. Similarly, the y control section generates the necessary signals to steer the beam in a plus or minus y direction. The steering signals produced by the x control section 2642 and the y control section 2644 are determined based on a scan angle input received on the digital control bus 2618. In one embodiment, the scan angle input information includes data defining azimuth angle and an elevation angle. The controller 2606 also includes a control input 2646 for receiving error control signals from the built-in test equipment (BITE) 2640.

The built-in test equipment (BITE) 2640 is used to correct for errors introduced in beam direction by the system including the beamformer 2604. The delay elements of the beamformer are typically analog devices and may not give a precise delay time for an applied control voltage. The delay time may vary due to factors such as temperature, aging, and applied voltage. Also, the applied delay time may vary from time to time due to the electromechanical nature of the delayer. Accordingly, the BITE 2640 is used to detect the error introduced and provide a feedback signal to the control input 2646 of the controller. Operation of the BITE 2640 will be described in further detail below.

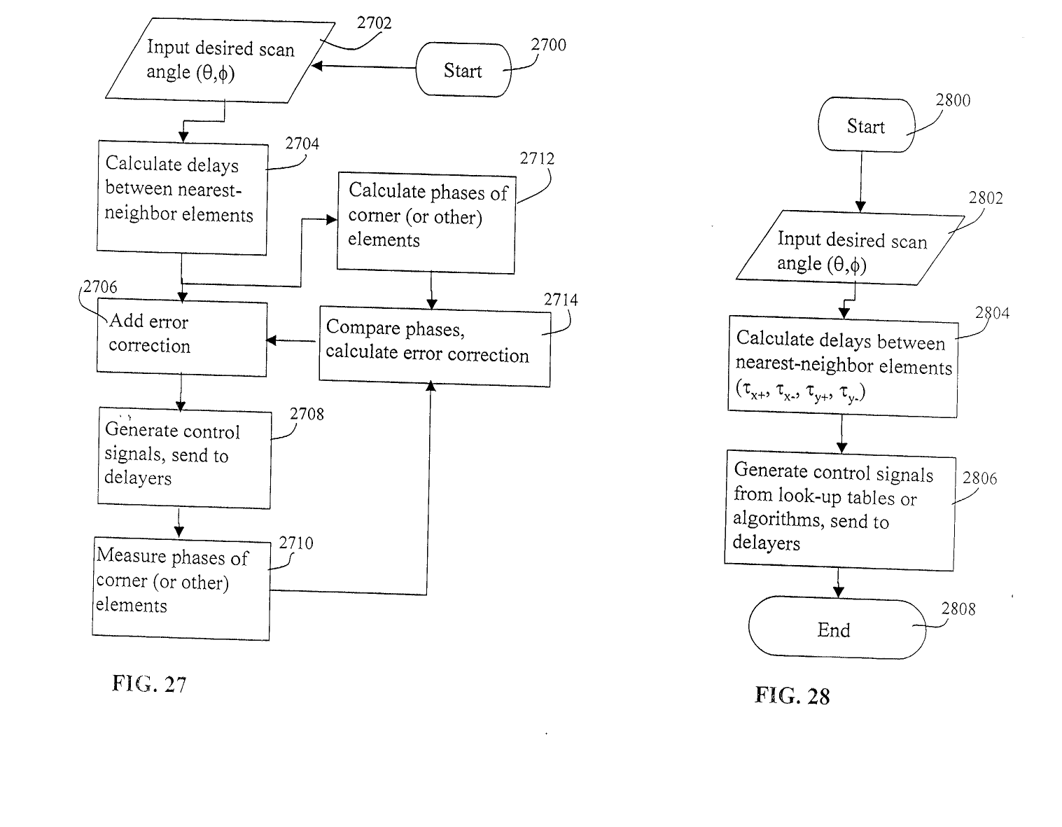

FIG. 27 is a flow diagram illustrating one embodiment of a method for operating a phased array system. The method begins at block 2700.

At block 2702, a desired scan angle is provided to the phased array system such as the antenna system 2600 of FIG. 26. The scan angle in one embodiment is a first angle defining an azimuth and a second angle defining elevation for a beam of the antenna system. The received angle may have any format, including digital data defining the scan angle and analog signals related to values of the scan angle.

At block 2704, delays between nearest neighbor elements of a fractal corporate power divider with variable true time delay are calculated. Preferably, the delays correspond to delays to be implemented by variable time delay transmission line segments of the beamformer of the antenna system. The delays are calculated based on the scan angle received at block 2702. At block 2706, an error correction is added, to be described below.

At block 2708, control signals appropriate for controlling the variable time delay elements are generated. These control signals are conveyed from the antenna control unit to the beamformer. At block 2710, the phases of the signal occurring at selected locations of the beamformer are measured by the built-in test equipment (BITE) associated with the beamformer. In one embodiment, elements at the four corners of the beamformer are used for the phase measurement. Other elements of the beamformer may be substituted.

At block 2712, the expected phases of the signals at the selected elements, such as the corner elements, of the beamformer are calculated by the built-in test equipment based on the delays calculated at block 2704. At block 2714, the expected phases and the measured phases are compared. Based on this comparison, an error correction is determined which will correctly align the beam associated with the antenna system to compensate for variations in the antenna system. The error correction is added to the calculated delays at block 2706.

The method in accordance with the embodiment of FIG. 27 thus provides correction for systematic errors, such as those occurring due to temperature variation, aging and non-uniformities of components. This system does not correct for randomly occurring errors which cannot be measured and compensated. The embodiment illustrated in FIG. 27 implements an open loop control method for error detection and correction by a phased array system such as the antenna system described herein.

FIG. 28 is a flow diagram illustrating a second embodiment of a method for operating a phased array system such as the antenna system illustrated in FIG. 26. FIG. 28 illustrates a method for operating the system without intervention of the built-in test equipment (BITE). The method begins at block 2800.

At block 2802, the desired scan angle is provided to the antenna system. This may be accomplished, for example, by providing digital data related to the desired azimuth and elevation angles to the antenna control unit associated with the antenna system. Alternatively, analog signals related to the desired angle can be provided.

At block 2804, based on the received desired scan angle, delays between nearest neighbor elements are calculated. At block 2806, the necessary control signals to steer the beam associated with the antenna system in the direction of the desired scan angle are calculated. The calculation or generation of these control signals may occur using look-up tables, various algorithms, etc. Further, in block 2806, the necessary control signals are communicated to the delayers of the beamformer. The process for steering the beam using the antenna control unit ends at block 2808.

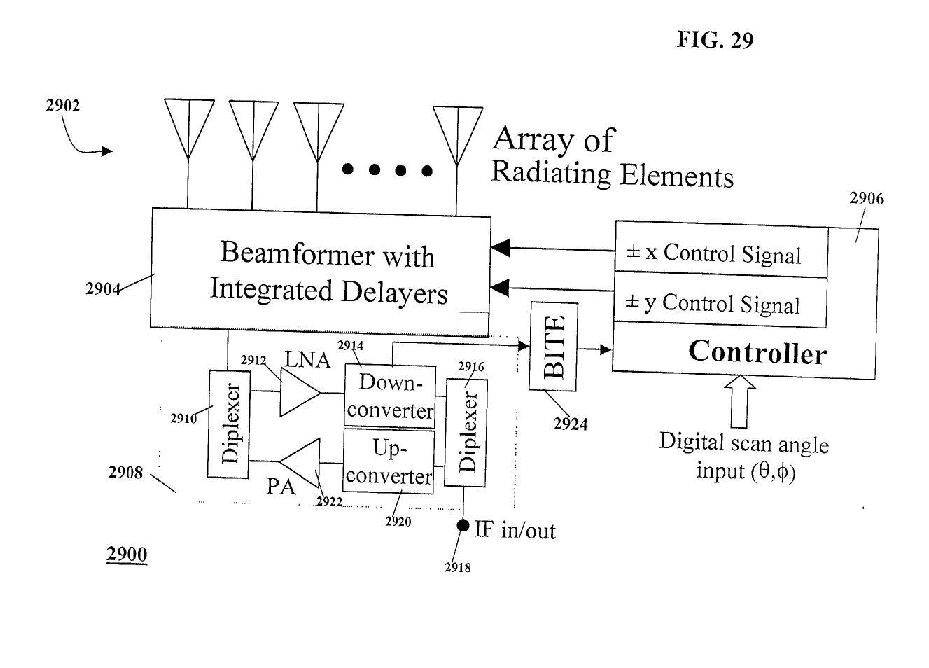

FIG. 29 is a block diagram of a third embodiment of an antenna system 2900. The antenna system 2900 includes an array of radiating elements 2902, a beamformer 2904 and a controller 2906. The antenna system 2900 in the embodiment of FIG. 29 further includes a radio frequency to intermediate frequency circuit 2908 and build-in test equipment 2924. The RF to IF circuit 2908 includes a diplexer, a low-noise amplifier (LNA) 2912, a down-converter 2914, a diplexer 2916, an up-converter 2920 and a power amplifier (PA) 2922.

The beamformer 2904 has a feed port 2930 and preferably includes a two-dimensional arrangement of output ports. The radiating antenna elements 2902 are coupled with output ports of the beamformer 2904. The antenna control unit 2906 is coupled with the beamformer 2906 to steer a beam of the antenna system 2900. The diplexer 2910 of the RF to IF circuit 2908 is coupled with the feed port 2930 of the beamformer 2904. For reception, radio frequency (RF) signals from the feed port 2930 are provided by the diplexer to the LNA 2912. The amplified signals from the LNA 2912 are provided to down-converter 2914. The down-converter 2914 reduces the frequency of the received signals from radio frequency to intermediate frequency levels. The output IF signal from the down-converter is provided to the BITE 2924 and to the diplexer 2916. From the diplexer, the received IF signal is provided to an IF port 2918. For transmission, IF signals received at the IF port 2918 are increased in frequency in the up-converter 2920, producing RF signals. The RF signals are amplified in the PA 2922 and provided to the diplexer 2910. The diplexer 2910 conveys the amplified RF signals to the feed port 2930 of the beamformer 2904.

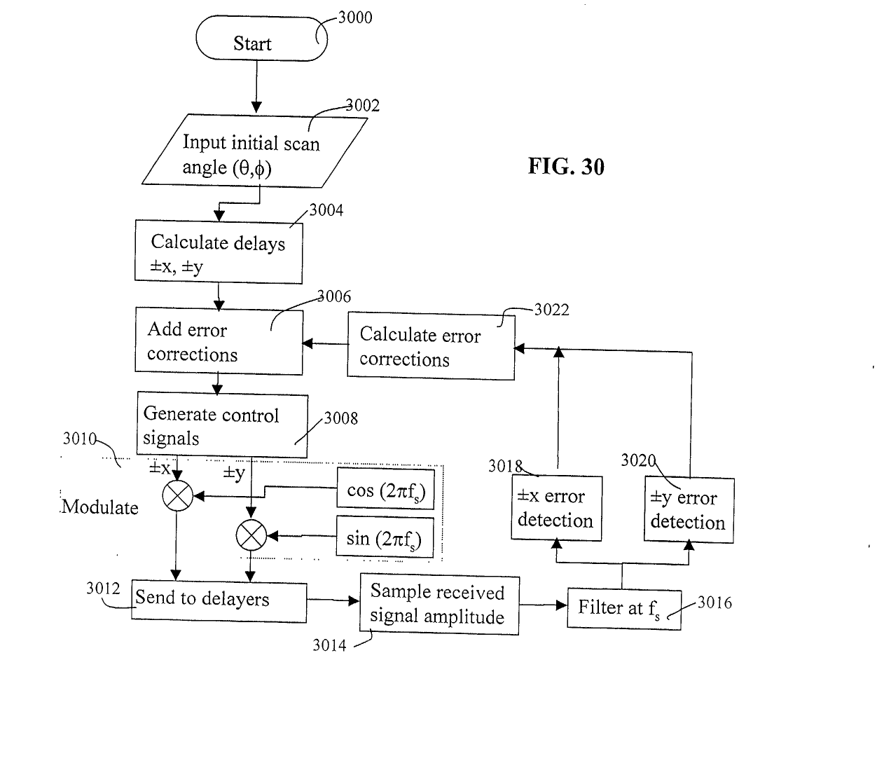

FIG. 30 is a flow diagram illustrating a third embodiment of a method for operating a phased array system. The method begins at block 3000.

At block 3002, information defining an initial scan angle is provided to the phased array system. This information may be in the form of digital data or analog signals defining the initial scan angle. The initial scan angle may be defined by providing an azimuth angle and an elevation angle.

At block 3004, the delays necessary for directing a beam from a beamformer of the phased array system are calculated based on the input initial scan angle information. Preferably, the delays are calculated in plus or minus x and plus or minus y directions. At block 3006, error corrections, to be calculated as described below, are added to the delay values calculated at block 3004. At block 3008, the control signals necessary to control the direction of beam provided by the beamformer of the phased array system are generated. The control signals preferably activate time delay transmission elements of the beamformer, the time delay elements having a particular distribution of delayers throughout the beamformer.

At block 3010, prior to conveying the control signals to the delayers, a modulation of the control signals is introduced. This is shown schematically in the flow diagram of FIG. 30. However, any suitable control circuit may be implemented to perform the described function. A scanning frequency fₛ is selected for scanning the direction of the beam from the beamformer and the antenna system. A cosine of the scanning signal is determined and used to modulate the plus or minus x control signals generated in block 3010. Similarly, sine values of the modulating frequency fₛ are used to modulate the plus or minus y control signals generated in the block 3008. By applying this modulation in the x and y direction at a scanning frequency, the beam can be scanned about a pointing direction selected by the control signals at block 3008. For example, the direction associated with the control signals generated at block 3008 may be a best-guess or approximation based on the input initial scan angle received at block 3002. Because of non-uniformities in the beamformer and environmental variations, error may be introduced. To detect and compensate for such error, the modulation introduced at block 3010 allows the beam to hunt in the vicinity of the initial scan angle for a best-corrected angle to use for optimal performance.

At block 3012, the modulated control signals are conveyed to the delayers of the beamformer and used to form a beam directed at a corrected angle whose position is modulated according to the scanning frequency of fₛ. At block 3014, the amplitude of the received signal is sampled. The sampled signal is filtered at the scanning frequency fₛ at block 3016. At block 3018, error in the plus or minus x direction is detected and at block 3020, error in the plus or minus y direction is detected. At block 3022, appropriate error corrections are calculated based on the detected error. These error corrections are added to the calculated delays at block 3006.

Thus, the method of FIG. 30, in conjunction with a system such as the system of FIG. 29, implements a closed-loop phased array system in which feedback is used to establish a correction for the pointing angle of the beam. A modulating signal and a scan frequency is applied to steer the beam about an initial scan angle. A received signal is analyzed for signal quality. The quality of the received signal is optimized by steering the beam to correct for any error introduced in the signal.

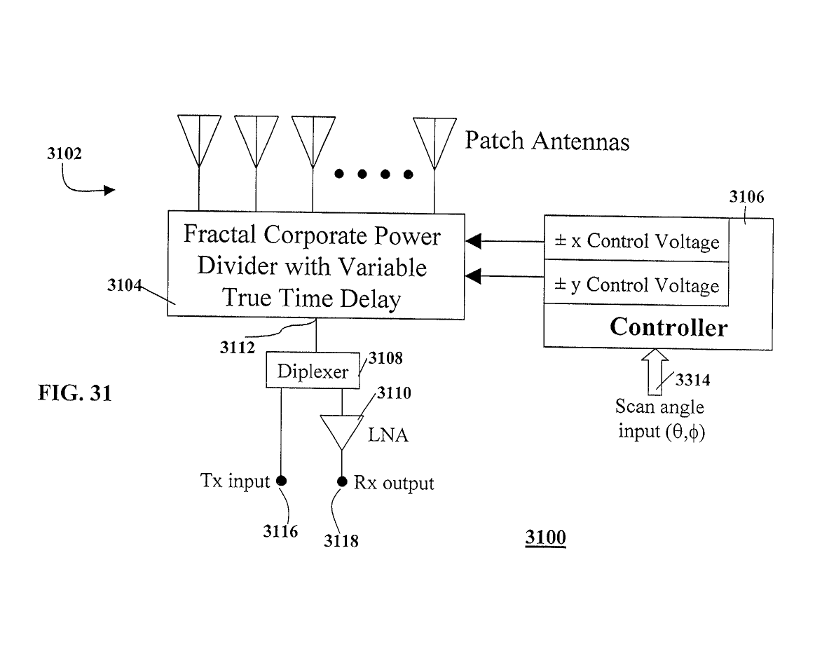

FIG. 31 is a block diagram showing a fourth embodiment of an antenna system. The embodiment of FIG. 31 is particularly well-suited for use in conjunction with a radio engaged in radio communication with an earth orbiting satellite. The radio may be fixed or mobile. The phased array antenna system 3100 of FIG. 31 may be used to point a beam to begin communication with the satellite and scan the beam to follow the satellite as the satellite moves across the sky.

The antenna system 3100 includes radiating elements 3102, a beamformer 3104 formed as a fractal corporate power divider with variable true time delay, and an antenna controller 3106. For electrical connection to transmitting and receiving circuitry of the radio, the antenna system 3100 includes a diplexer 3108 and a low-noise amplifier 3110.

The radiating elements 3102 in the illustrated embodiment include a plurality of patch antennas. The radiating elements 3102 have radio frequency (RF) connections driven by the beamformer 3104. The beamformer 3104 may be embodied in accordance with any of the beamformer embodiments described herein, or any other suitable beamformer embodiment. Preferably, the beamformer has a feed port 3112 and is formed from a two-dimensional output arrangement of output ports which are electrically coupled with the radiating elements 3102.

The controller 3106 receives a scan angle at an input port 3114 and generates control signals appropriate to control or steer the beam associated with the antenna system and produced by the beamformer 3104. The scan angle information received by the controller may be in any suitable format, such as digital data or analog control signals. The controller 3106 may determine the appropriate control signals by any suitable method including by means of a look-up table or by calculating the appropriate control signals using any suitable algorithm.

The diplexer 3108 is coupled with the feed port 3112 of the beamformer 3104. The diplexer 3108 has a transmit input 3116 for receiving RF signals for transmission from the antenna system 3100. For reception of RF signals, the diplexer 3108 is coupled with the input of the low-noise amplifier 3110. The output of the low-noise amplifier 3110 is provided at a receive output 3118. The transmit input 3116 and the receive output 3118 may be suitably electrically coupled with other circuitry of a radio incorporating the antenna system 3100.

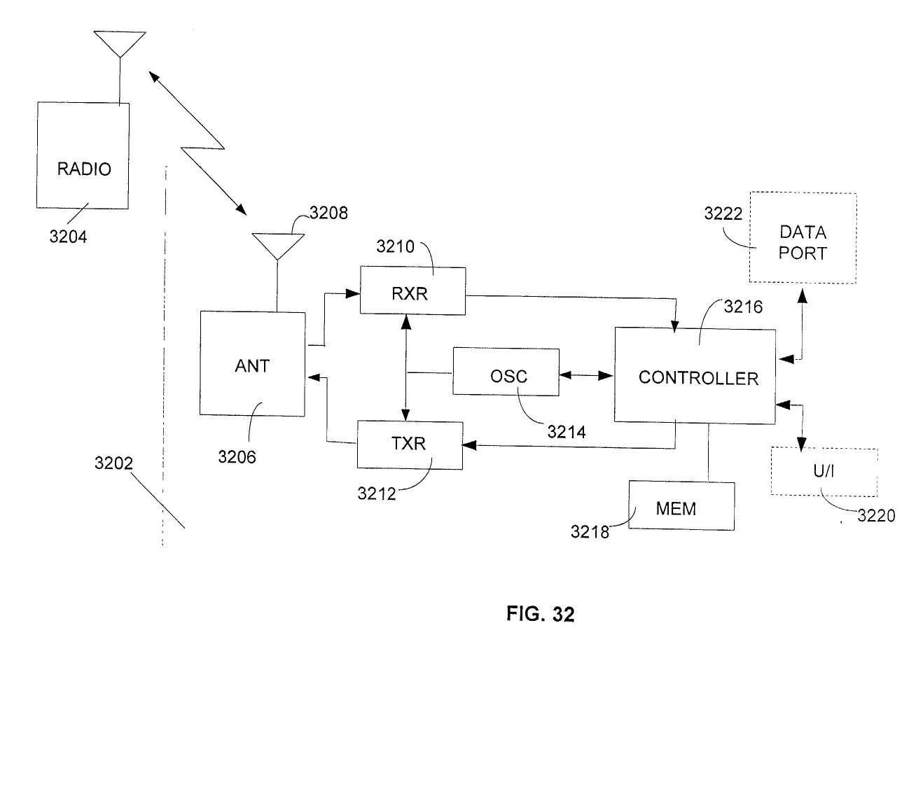

FIG. 32 is a block diagram of a radio system 3200. The radio system 3200 includes a radio 3202 in radio communication with a remote radio 3204. In one embodiment, the radio 3202 is one node in a radio system such as a LMDS or MMDS radio system, in communication with a second node of the system formed by the remote radio 3200 both nodes being stationary but with the radio link between them being optimized by steering a beam of a phased array antenna system of the radio 3202, in accordance with the present embodiments. In other embodiments, one or both radios is mobile and the radio link between them is maintained by steering a beam of the phased array antenna system of the radio 3202, in accordance with the present embodiments. In an example of such an embodiment, the radio 3202 is a portion of user equipment (UE) in a satellite-based radio communication system and the remote radio 3204 is associated with an earth-orbiting satellite of the system. In this exemplary embodiment, the radio 3202 includes a phased array antenna system capable of tracking the movement of the remote radio 3204 across the sky to maintain radio communication between the radio 3202 and the remote radio 3204.

The radio 3202 includes an antenna system 3206 including an antenna 3208, a receive circuit 3210, a transmit circuit 3212, an oscillator 3214, a controller 3216, a memory 3218, a user interface 3220 and a data port 3222. The antenna system 3206 and antenna 3208 are preferably formed and operated in accordance with any of the embodiments described herein or other equivalent embodiments. In particular, the antenna system 3206 preferably includes an antenna control unit and true-time-delay beamformer operable with a phased array antenna 3208, the beamformer utilizing a planar corporate power divider disposed in a fractal arrangement to distribute energy between an input port and a two-dimensional grid of output ports which correspond to antenna elements of the antenna 3208. Preferably, as described herein, controllable, variable time-delay devices are incorporated in the branches of the fractal power divider in such a manner that a progressive time delay is created at the output ports by using a minimal number of control signals. The antenna system 3206 thus permits two-dimensional beam steering controllable by, for example, only four control signals produced by the antenna control unit with a resulting beam-pointing angle that is constant over a very broad bandwidth of frequencies. The antenna system includes one or more receive radio frequency (RF) feed ports for communication of electrical RF signals.

The receive circuit 3210 is configured to receive RF signals detected by the antenna system 3206 and antenna 3208. The receive circuit 3210 may be constructed in any suitable manner and will typically include circuits and devices appropriate for the data encoding, modulation technique and communication frequencies chosen for the radio system 3200. If the radio system 3200 is a digital radio system, the receive circuit may extract in-phase and quadrature data from the received RF signals and pass the data to the controller 3216. The transmit circuit 3212 operates in a complementary fashion, modulating a carrier with data from the controller 3216, amplifying the resulting RF signal and providing the amplified signal to the antenna system 3206 for transmission. The oscillator 3214 may be included in the radio 3202 to produce local oscillator (LO) signals for tuning, modulating and mixing received and transmitted radio signals, as is well known in the art.

Where appropriate, one or more of the components of the receive circuit 3210, the transmit circuit 3212 and the oscillator 3214 may be combined with the components of the antenna system 3206. For example, as described above, the beamformer of the antenna system 3206 and the phased array antenna 3208 may be combined in a multi-layer module using printed circuit board technology. Components such as a low noise amplifier (LNA) of the receive circuit 3210 or the power amplifier (PA) of the transmit circuit 3212 may also be combined with such a printed circuit module to reduce parts count, size, weight, noise and interference in the radio 3202.

The controller 3216 controls operation of the radio 3202. The controller 3216 may be embodied as a microprocessor, digital signal processor or a logic circuit configured to perform the control functions necessary to control the operation of the radio 3202. The memory 3218 stores data and instructions for use by the controller 3218. The controller 3216 controls other components of the radio 3202 including the receive circuit 3210 and transmit circuit 3212, the oscillator 3214, and the antenna system 3206. For example, the controller 3216 may provide control signals to the receive circuit 3210 and transmit circuit 3212 to activate these circuits when timing indicates a radio reception or transmission is due. The controller 3216 may provide control signals to the oscillator 3214 to tune the oscillator to one or more desired receive or transmit frequencies. The controller 3216 may provide control signals to the antenna system 3206 to specified a desired scan angle for the antenna system. Accordingly, the radio 3202 includes other data and control connections not shown in FIG. 32 so as to not unduly complicate the drawing figure.

For embodiments in which the radio 3202 may be controlled by a user, the user interface 3220 permits such control. In typical embodiment, the user interface 3220 includes a keyboard and a display device. In an embodiment where the radio system communicates voice information, the user interface 3220 may include a speaker and a microphone.

For embodiments in which the radio 3202 communicates data, such as a satellite data communication system, or an LMDS or MMDS system, the radio includes the data port 3222 for communicating data with other devices over other electrical connections not shown in FIG. 32. The data communication may be two-way and the data port may translate and format the data between a form for radio communication by the radio 3202 and for electrical communication within an associated data system.

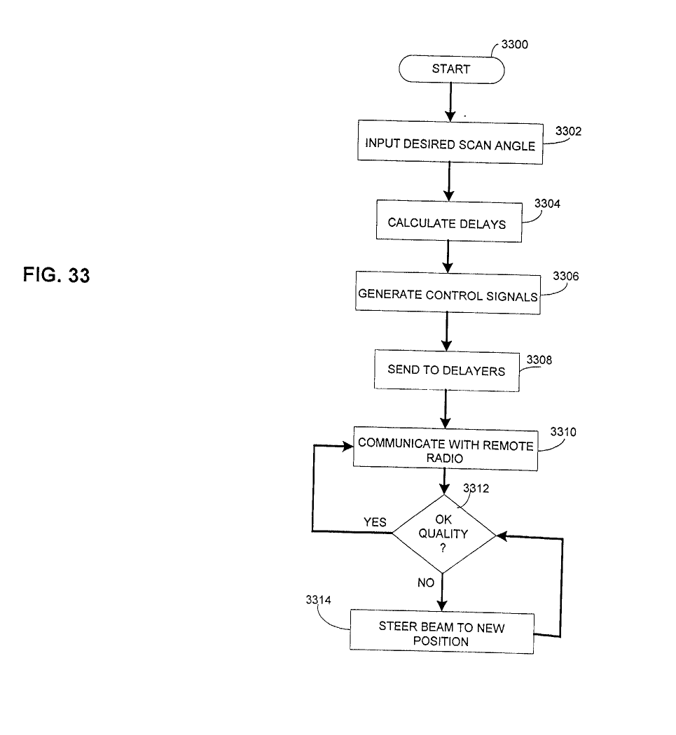

FIG. 33 is a flow diagram illustrating one embodiment of a method for operating the radio system 3200 of FIG. 32. The method begins at block 3300. At block 3302, a desired scan angle is provided to the antenna system 3206. In one at embodiment, data corresponding to the desired scan angle are provided by the controller. The data may be determined from an expected or previously-stored position for the remote radio 3204. The data may further specify a scan frequency, amplitude or other information for scanning the beam produced by the antenna system 3206 and antenna 3208.

At block 3304, the delays appropriate for the individual delayers of the corporate fractal beamformer of the antenna system 3206 are calculated. In block 3306, the necessary control signals for the beamformer are generated. In one embodiment, this delay calculation and control signal generation are performed in the antenna system. Alternately, calculation could be performed in the controller 3216 of the radio and only data related to the delays communicated to the antenna system. If the control signals are digital in nature, the control signals may also be generated in the controller 3216 for the radio 3202. In such an embodiment, the memory 3218 may be used as a look up table for determining appropriate delays or control signals. In general, the processing load may be distributed among the circuits of the radio 3202 in any suitable manner.

At block 3308, the control signals are sent to the delayers of the beamformer. These control signals configure the individual delayers of the beamformer and establish time delays between the input port of the beamformer and the output ports of the beamformer. This steers the beam produced by the beamformer in association with the antenna 3208 so that RF signals provided to the antenna system by the transmit circuit 3212 or detected by the antenna system and provided to the receive circuit 3210 are selected according to their direction relative to the antenna 3204.

At block 3310, communication with a remote radio begins. Communication may be one-way or two-way communication. Communication may include two-way encoding, modulation, demodulation and decoding of data. Alternatively, communication may include only detecting a signal produced by the remote radio, such as a control signal or a paging signal. Alternatively, communication may include only transmitting a signal in a direction in the vicinity of the remote radio for reception by the remote radio.

At block 3312, the radio 3202 determines if the signal quality is acceptable. This may be done in any suitable manner. For example, a signal quality parameter such as received signal strength indicator (RSSI) circuit of the receive circuit may be monitored for variation from a set point. Similarly, the remote radio 3204 may provide a feedback transmission to indicate its received signal quality as an indication of the quality of the transmitted signal and radio link between the two radios 3202, 3204. Other signal quality techniques may be used as well and other signal parameters not related to quality may be substituted.

At block 3312, if the signal quality is acceptable, control returns to block 3310 and communication with the remote radio continues. Alternatively, if at block 3312 it is determined that signal quality is not acceptable, at block 3314 the radio 3202 steers the beam to a new position to improve the signal quality. Control remains in a loop including block 3312 and block 3314.

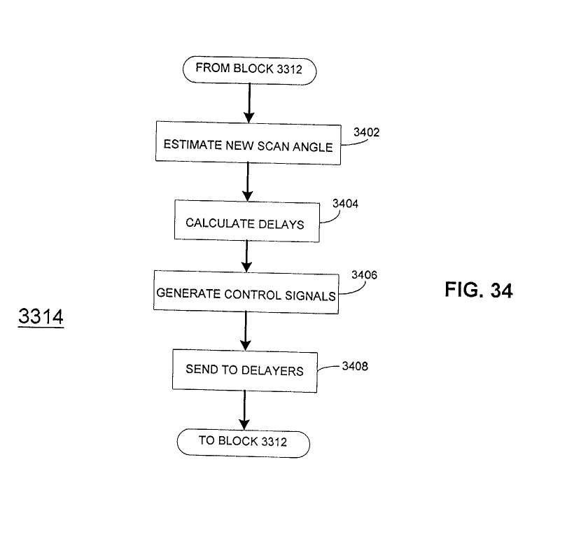

FIG. 34 is a flow diagram illustrating one embodiment of block 3314 in FIG. 33. The acts of block 3314 steer the beam from the beamformer phased array antenna system to a new position. This may occur for example, if the beam has become misaligned because one or both radios have moved or because of environmental change at one or both radios.

At block 3402, a new pointing angle for the beam is estimated. The estimate may be based on any suitable information. For example, historical information for beam misalignment and movement may be used. If the beam variation has been along a particular path and the radio has stored information indicative of that historical variation, the data may be used to form an estimate of a new pointing angle. Alternatively, the estimate may be based on a best guess for a new pointing angle or may be along a path with high likelihood of accurately realigning the beam. In one example, the beam may be redirected to point along a spiral path with pauses between each redirection to test signal quality.

At block 3404, based on the estimate for the new scan angle, the delays appropriate for the true-time-delay transmission line elements are calculated and at block 3406, the necessary control signals are generated. The control signals are communicated to the delayers of the beamformer, block 3408, and control proceeds to block 3312 to test the effect of the new beam position on signal quality or other signal parameters.

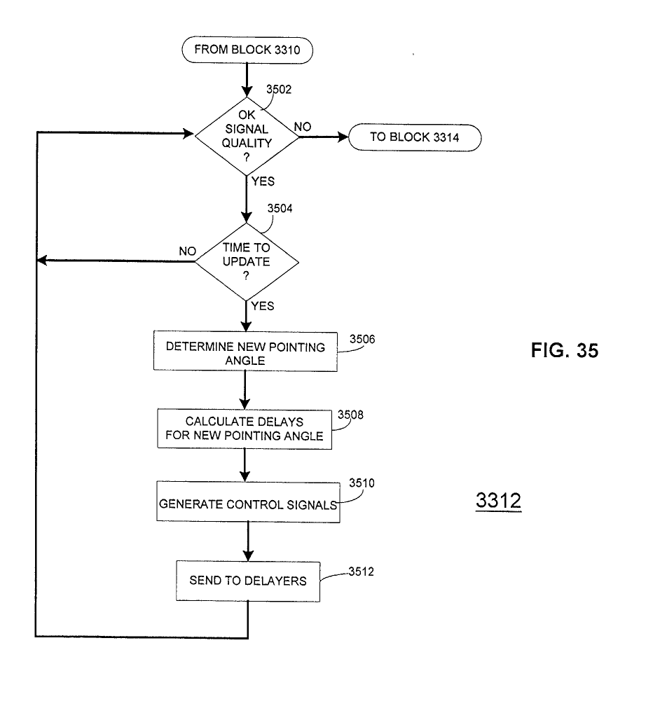

FIG. 35 is a flow diagram illustrating one embodiment of block 3312 in FIG. 33. The method acts illustrated in FIG. 35 illustrate an operation in which beam position of the fractal, true-time-delay corporate power dividing beamformer is updated based on either reduced signal quality or variation of another signal parameter, or upon elapse of a set update duration. Thus, the illustrated embodiment is useful for tracking a predictably moving remote radio such as an orbiting satellite while updating beam position by monitoring signal quality. Alternatively but equivalently, the illustrated embodiment is useful for tracking a fixed remote radio from a moving or mobile radio. Since these cases are equivalent, with the motion being determined based only on the frame of reference, only the single case of tracking a moving remote radio from a stationary or moving radio will be discussed but is applicable to the other cases as well.

At block 3502, the signal quality is tested. This may be achieved according to any of the techniques described herein or by any other suitable technique. If the present signal quality is not acceptable, control proceeds to block 3314, FIG. 33, to adjust the beam position. If present signal quality is acceptable, at block 3504 it is determined if it is now time to update the beam position. This may occur, for example, if the radio is following or tracking another remote radio such as a satellite in a satellite communication system. In such a system, whether the radio is fixed or mobile, the remote radio will adjust its beam to continuously follow the position of the remote radio.

At block 3506, a new pointing angle for the antenna beam is determined. This determination may be made based on any available information. For example, if the radio is tracking a regularly-moving remote radio, the new pointing angle may be estimated based on extrapolated data. Alternatively, the path and position of the moving remote radio may be completely determined based on time. This is true, for example, in the Global Positioning System (GPS), where the position of the GPS satellites is directly tied to time information. In such a case, the pointing angle may be determined by reading a current time or even receiving current system time from the radio system, performing a look up operation in a table stored in memory, and determined pointing angle directly from the retrieved data or based on additional calculations. In still another embodiment, the new pointing angle may be communicated to the radio from another source such as the remote radio itself.

At block 3508, based on the new pointing angle, the delays appropriate for the true-time-delay transmission line elements are calculated and the necessary control signals are generated at block 3510. The control signals are communicated to the delayers of the beamformer, block 3512, and control proceeds to block 3502 to test the effect of the new beam position on signal quality. If quality is inadequate, control may proceed to block 3314 to attempt to steer the beam to improve signal quality.

From the foregoing, it can be seen that the present embodiments provide an electromechanical scanned array system and method. An antenna system includes a beamformer including variable true-time-delay transmission line elements between a feed port and output ports. An antenna control unit or other source provides control signals to the beamformer to control the respective time delays. A beam of RF signals is steered using the beamformer and radiating elements of an associated antenna. The antenna system can thus be used to track a moving remote radio and to initially point and align a radio, for example, upon installation of a new radio in a radio system. The antenna system can further be used to realign the beam between the radio and another radio either automatically or manually, either because of repositioning or variation in the equipment.

It can further be seen that the present invention provides an antenna system which includes a beamformer having a feed port and a two dimensional arrangement of output ports, radiating antenna elements coupled with output ports of the beamformer, and an antenna control unit coupled with the beamformer to steer a beam of the antenna system. The antenna system forms an electrically steerable, phased array antenna having a beam steering angle which is constant over a very broad band of frequencies. Specific applications for the antenna system include satellite communications including tracking low earth orbiting satellites, radar systems and data links using a steerable antenna for self-installation, self-healing and adaptation.

While a particular embodiment of the present invention has been shown and described, modifications may be made. It is therefore intended in the appended claims to cover such changes and modifications which follow in the true spirit and scope of the invention.

1. An antenna system comprising:
a beamformer having a feed port and an arrangement of output ports;
radiating antenna elements coupled with output ports of the beamformer; and
an antenna control unit coupled with the beamformer to steer a beam of the antenna system.

2. The antenna system of claim 1 wherein the arrangement of output ports comprises a two-dimensional arrangement.

3. The antenna system of claim 2 wherein the beamformer includes a control port configured to receive two or more control signals and wherein the antenna control unit is configured to provide the two or more control signals to steer the beam of the antenna system.

4. The antenna system of claim 3 further comprising:
built in test equipment (BITE) coupled with the beamformer and configured to determine a phase estimate for the beamformer.

5. The antenna system of claim 4 wherein the antenna control unit is coupled with the BITE and further configured to receive the phase estimate and to generate an error correction in response to the phase estimate.

6. The antenna system of claim 5 wherein the antenna control unit is configured to update the two or more control signals in response to the phase estimate.

7. An antenna system comprising:
a fractal corporate power divider beamformer having a feed port and output ports;
radiating antenna elements coupled with output ports of the beamformer; and
an antenna control unit coupled with the beamformer to steer a beam of the antenna system.

8. The antenna system of claim 7 wherein the beamformer comprises:
a fractal array of delayers, each delayer having a variable delay controllable by a control signal.

9. The antenna system of claim 8 wherein the antenna control unit comprises:
a first calculating circuit configured to determine delays for delayers of the beamformer in response to a selected scan angle; and
a signal generating circuit configured to produce control signals for the fractal array of delayers in response to the determined delays.

10 The antenna system of claim 9 further comprising:
built in test equipment (BITE) coupled with the beamformer and the antenna control unit and configured to determine phase information for two or more delayers of the beamformer and provide the phase information to the antenna control unit.

11. The antenna system of claim 10 where the antenna control unit is configured to determine an error correction based on the phase information, the signal generating circuit producing corrected control signals for the fractal array in response to the error correction.

12. A radio comprising:
a transmit circuit;
a receive circuit;
a diplexer coupled with the transmit circuit and the receive circuit;
two or more radiating antenna elements;
a fractal corporate power divider beamformer having a feed port coupled with the diplexer and two or more output ports coupled with the two or more radiating antenna elements; and
an antenna control unit configured to provide control signals to the beamformer to steer an antenna beam.

13. The radio of claim 12 further comprising:
an oscillator configured to generate one or more oscillating signals at a transmit frequency and a receive frequency; and
a controller coupled with the oscillator and the antenna control unit.

14. The radio of claim 12 further comprising:
a built in test circuit coupled with the fractal corporate power divider beamformer and configured to measure phase at a plurality of radiating antenna elements and provide a phase indication to the antenna control unit.

15. The radio of claim 13 wherein the antenna control unit is configured to determine an error correction based on the phase indication and provide corrected control signals based on the error correction.

16. The radio of claim 14 wherein the antenna control unit is configured to produce modulated control signals and identify an error correction based on the modulated control signals, the antenna control unit further configured to provide corrected control signals based on the error correction.

17 A method for directing a beam of an antenna, the method comprising:
receiving information associated with a desired scan angle;
calculating delays between delayers of a fractal corporate power divider beamformer;
generating control signals based on the calculated delays; and
communicating the control signals to the beamformer.

18. The method of claim 17 further comprising:
receiving phase information for predetermined delayers of the beamformer;
calculating error correction based on the phase information;
updating the control signals based on the error correction; and
communicating the updated control signals to the beamformer.

19. A self-installing radio operable in a radio system, the self-installing radio comprising:
radio equipment for radio communication with a remote radio of the radio system;
an antenna system coupled with the radio equipment and including:
a planar, fractal beamformer having a plurality of controllable variable time delay elements responsive to control signals for delaying radio frequency (RF) signals between a feed port and a plurality of output ports, and
an array of radiating elements coupled with the plurality of output ports; and
a control circuit coupled with the beamformer to provide the control signals in response to an estimation of a pointing angle to the remote radio.

20. The self-installing radio of claim 19 wherein the control circuit is configured to vary the control signals to vary the pointing angle until a signal quality parameter is optimized.

21. The self-installing radio of claim 20 wherein the control circuit is configured to determine a new pointing angle, calculate delays for the plurality of controllable variable time delay elements of the beamformer and generate the control signals to establish the calculated delays at the beamformer.

22. The self-installing radio of claim 19 wherein the control circuit is configured to detect a variation in a signal quality parameter and, in response, vary the control signals to vary the pointing angle until a signal quality is optimized.

23. An antenna system for user equipment (UE) of a satellite radio communication system including a plurality of earth-orbiting satellites, the antenna system comprising:
a planar, fractal beamformer having a plurality of controllable variable time delay elements responsive to control signals for delaying radio frequency (RF) signals between a feed port and a plurality of output ports, and
an array of radiating elements coupled with the plurality of output ports; and
a control circuit coupled with the beamformer to provide the control signals in response to an estimation of a pointing angle to a satellite of the satellite radio communication system.

24. A radio for use with user equipment (UE) of a satellite radio communication system including a plurality of earth-orbiting satellites, the radio comprising:
radio equipment for radio communication with one or more satellite radios of the satellite radio system;
an antenna system coupled with the radio equipment and including
a planar, fractal beamformer having a plurality of controllable variable time delay elements responsive to control signals for delaying radio frequency (RF) signals between a feed port and a plurality of output ports, and
an array of radiating elements coupled with the plurality of output ports; and
a control circuit coupled with the beamformer to provide the control signals in response to an estimation of a pointing angle to the satellite radio.

25. The radio of claim 24 wherein the control circuit is configured to calculate an updated pointing angle matching motion of the satellite radio and to update the control signals to point the beam at the satellite radio as the satellite radio moves.

26. An open loop steering method for a phased array antenna system, the method comprising:
(a) determining a desired scan angle for a beam of the phased array antenna system;
(b) based on the desired scan angle, determining delays for time delay devices of a beamformer of the phased array antenna system;
(c) based on the delays, producing a plurality of control signals;
(d) providing the control signals to the beamformer;
(e) at the beamformer, in response to the control signals, establishing time delays between a feed port and output ports of the beamformer;
(f) providing a radio frequency signal to the feed port of the beamformer; and
(g) selectively delaying the RF signal according to the established time delays to provide delayed output signals from the output ports to radiating elements of the beamformer.

27. The open loop steering method of claim 26 wherein determining the delays based on the desired scan angle comprises looking up delay information in a memory using desired scan angle information.

28. The open loop steering method of claim 26 wherein determining the delays based on the desired scan angle comprises calculating delay information according to a predetermined algorithm and the desired scan angle.

29. The open loop steering method of claim 26 wherein providing the control signals to the beamformer comprises providing digital data related to the delays.

30. The open loop steering method of claim 26 further comprising:
(h) determining phase information;
(i) based on the phase information, determining a beam angle error; and
(j) based on the beam angle error, determining an error correction.

31. The open loop steering method of claim 31 further comprising:
(k) based on the error correction, producing a plurality of corrected control signals;
(l) providing the corrected control signals to the beamformer;
(m) at the beamformer, in response to the corrected control signals, establishing corrected time delays between the feed port and the output ports of the beamformer;
(n) providing a radio frequency signal to the feed port of the beamformer;
(o) selectively delaying the RF signal according to the corrected time delays to provide delayed output signals from the output ports to radiating elements of the beamformer.

32. The open loop steering method of claim 31 further comprising:
(p) repeating acts (h) through (o) to maintain the desired scan angle of the beam.

33. A closed loop steering method for a phased array antenna system, the method comprising:
(a) determining a desired scan angle for a beam of the phased array antenna system;
(b) based on the desired scan angle, determining delays for time delay devices of a beamformer of the phased array antenna system;
(c) based on the delays, producing a plurality of control signals;
(d) modulating the control signals to modulate the scan angle;
(e) providing the modulated control signals to the beamformer;
(f) at the beamformer, in response to the modulated control signals, establishing time delays between a feed port and output ports of the beamformer;
(g) sampling a received signal detected of the phased array antenna system;
(h) determining error corrections based on the sampled received signal;
(i) producing corrected control signals based on the error corrections;
(j) providing the corrected control signals to the beamformer.

34. The closed loop steering method of claim 33 further comprising: (g1) filtering modulation from the received signal.

35. A method for a radio including a phased array antenna system, the method comprising:
applying control signals to variable time delay elements of a planar fractal beamformer to steer an antenna beam;
detecting a signal indication associated with radio communication with a remote radio target; and
steering the antenna beam to vary the signal indication.

36. The method of claim 35 wherein detecting the signal indication comprises:
transmitting a radio signal;
measuring phase information for the transmitted radio signal; and
detecting an error correction based on the phase information.

37. The method of claim 35 further comprising:
modulating a pointing angle of the antenna beam;
receiving radio signals from the remote radio target; and
based on the received radio signals, determining an error correction for the pointing angle of the antenna beam.

38. The method of claim 35 further comprising:
detecting a subsequent reduction in the signal quality indication; and
applying corrected control signals to the time delay elements to steer the antenna beam to improve the signal quality indication.

39. A method for a radio including a phased array antenna system, the method comprising:
steering an antenna beam to a remote radio target with a planar fractal beamformer;
detecting a signal quality indication associated with radio communication with the remote radio target; and
applying corrected control signals to time delay elements of the planar fractal beamformer to steer the antenna beam to improve the signal quality indication.

40. A manufacturing method for a radio including a phased array antenna system, the method comprising:
determining a pointing angle for the phased array antenna system;
providing beam steering control signals to a planar fractal beamformer of the phased array antenna system;
fixing the beam steering control signals to permanently select the pointing angle for the phased array antenna system.
